(19) United States
(12) Patent Application Publication
(10) Pub. No.: US 2024/0261755 A1
(43) Pub. Date: Aug. 8, 2024

(54) ZINC-CONTAINING ZEOLITES AS DESICCANTS, AND METHODS OF USING THE SAME

(71) Applicant: California Institute of Technology, Pasadena, CA (US)

(72) Inventors: Donglong Fu, Pasadena, CA (US); Mark E. Davis, Pasadena, CA (US)

(21) Appl. No.: 18/638,805

(22) Filed: Apr. 18, 2024

Related U.S. Application Data
(62) Division of application No. 17/681,267, filed on Feb. 25, 2022.
(60) Provisional application No. 63/154,404, filed on Feb. 26, 2021.

(51) Int. Cl. B01J 20/18; B01D 53/02; B01J 20/28; B01J 20/30

(52) U.S. Cl. CPC B01J 20/186; B01D 53/02; B01J 20/28014; B01J 20/2808; B01J 20/3085; B01D 2253/1085; B01D 2253/308; B01D 2257/80; B01D 2258/06

(57) ABSTRACT

The present disclosure is directed to metal ion-containing zeolitic compositions, preferably transition metal ion-containing, more preferably zinc ion containing zeolitic compositions, that are useful for reversibly scavenging water from humid gaseous feed streams, including air, and method of making and using the same. In some embodiments, the compositions comprise zinc-ion-doped zeolites have LTA, FAU, or EMT topologies.

### CROSS REFERENCE TO RELATED APPLICATION

This application is a divisional of U.S. application Ser. No. 17/681,267 filed Feb. 25, 2022 which claims the benefit of U.S. Provisional Application No. 63/154,404, filed on Feb. 26, 2021, the entirety of which is incorporated by reference herein.

### TECHNICAL FIELD

The present disclosure is directed to metal ion-containing zeolitic compositions, preferably transition metal ion-containing, more preferably zinc ion-containing zeolitic compositions that are useful for scavenging water from low-water-content gaseous source mixtures (feed streams), including air, and methods of making and using the same. In some preferred embodiments, the compositions comprise zinc ion-doped zeolites having FAU, LTA, and EMT topologies capable of efficiently removing water from low-water-content gaseous source mixtures.

### BACKGROUND

Removal of water from gaseous feed streams is an important step in a number of important research and industrial processes.

One method of removing water from such feed stream is by contacting the feed stream with an adsorbent that adsorbs water present in the feed stream, thereby removing the water from the feed stream. In some such processes, the gaseous feed stream is passed through a stationary bed of the adsorbant.

Desirable properties of an ideal adsorbant include low-cost, high water capacity to lower pressure drop, high selectivity for water, very low bed outlet humidity, low energy of adsorption to have low heat input at low temperature for water desorption, and fast kinetics of both adsorption and desorption.

### SUMMARY

The present disclosure is directed to metal ion-doped crystalline microporous aluminosilicate compositions comprising:
a three-dimensional aluminosilicate framework comprising at least one topology that is LTA, FAU, or EMT;
wherein the crystalline microporous aluminosilicate contains metal ions positioned within the framework lattice, wherein exposure of the composition to a gas source having a total pressure in a range of from 50 kPa to 125 kPa, a CO₂ content in a range of 250 to 425 ppm, and a water content in a range of 5% to 95% relative humidity at a temperature ranging from 0° C. to 70° C., results in:
(i) the composition adsorbing less CO2 on a mmol per gram basis than does the corresponding crystalline microporous aluminosilicate composition that is not metal ion-doped when exposed to the same conditions; and
(ii) the composition adsorbing from 0.5 to 200 water molecules per unit cell.

The present disclosure also is directed to compositions that are useful for scavenging water from low-water-content gaseous source mixtures (feed streams), including air, and method of making and using the same. In some embodiments, the compositions comprise metal ion-doped crystalline microporous aluminosilicate composition comprising:
a three-dimensionally aluminosilicate framework comprising at least one topology selected from LTA, FAU, and EMT;
wherein the crystalline microporous aluminosilicate contains metal ions, preferably transition metal ions, more preferably zinc ions, positioned within the framework lattice; and
wherein the metal ion-doped crystalline microporous aluminosilicate composition desorbs water at a lower temperature than the otherwise same crystalline microporous aluminosilicate composition that does not contain the metal ions when subjected to the same conditions.

In certain independent aspects:
(a) the aluminosilicate framework has a LTA, FAU, or EMT topology;
(b) the composition has a Si:Al atomic ratio in a range of from 1:1 to 50:1, or any one of the ranges defined elsewhere herein;
(c) the metal ions positioned within the framework lattice comprise a transition metal ion, preferably iron, cobalt, nickel, copper, zinc, or silver, more preferably zinc;
(d) the (transition) metal ions are present within the framework lattice in a range of from 0.5 to 90 metal ions per unit cell, or any one of the ranges defined elsewhere herein;
(c) the compositions contain or have the capacity to contain water in a range of from 0.5 to 200 adsorbed water per unit cell, when the metal ion-doped crystalline microporous aluminosilicate composition is exposed to a gas source having (i) a total pressure in a range of from 50 kPa to 125 kPa, or any one of the ranges or values defined elsewhere herein, for example about 100 kPa and (ii) a water content in a range of 5% to 95% relative humidity at a temperature ranging from 0° C. to 70° C., or any one of the ranges or values defined elsewhere herein;
(f) in those composition containing carbon dioxide, the carbon dioxide is desorbed at a temperature of less than 130° C., less than 125° C., less than 120° C., less than 115° C., less than 110° C., or less than 100° C.;
(g) the composition adsorbs less than 15 wt %, less than 10 wt %, or less than 5 wt % carbon dioxide, relative to the weight of the anhydrous metal ion-doped crystalline microporous aluminosilicate composition; and/or
(h) in those compositions containing water, the water desorbs at a temperature of less than 250° C., less than 225° C., less than 200° C., less than 175° C., or less than 150° C.

Certain embodiments provide that the compositions set forth herein can be prepared by methods comprising contacting a precursor crystalline microporous aluminosilicate with an aqueous solution of a salt of a suitable metal ion, and optionally rinsing the resulting metal ion-doped crystalline microporous aluminosilicate with water and/or optionally drying the metal ion-doped crystalline microporous aluminosilicate, wherein the salt is any one of the salts described elsewhere herein, and the method steps are optionally those described in the Examples.

Certain embodiments provide methods of capturing water from a gaseous source mixture, the method comprising contacting the metal ion-doped crystalline microporous aluminosilicate compositions set forth herein with the gaseous source mixture so as to adsorb the water into the composition, and optionally desorbing the water from the water laden metal ion-doped crystalline microporous aluminosilicate.

In certain independent aspects of these methods:
(a) the contacting of the metal ion-doped crystalline microporous aluminosilicate with the gaseous source mixture is done in the absence or without the use of a carbon dioxide scrubber; and/or
(b) the contacting of the metal ion-doped crystalline microporous aluminosilicate with the gaseous source mixture is done in the presence or with the use of a carbon dioxide scrubber.

Certain additional embodiments provide for the material configurations that allow for the practice of these methods.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale.

FIG. 1 shows the experimental setup and methodology for the adsorption/desorption measurements.

FIG. 2 shows X-ray diffraction (XRD) patterns for the as-synthesized zeolites.

FIG. 3 shows scanning electron micrographs (SEM) for as-synthesized zeolites.

FIG. 4 shows carbon dioxide adsorption capacity from a gas stream of 400 ppm carbon dioxide in helium at 30° C. The zeolites with D6MRs (AEI, AFX, CHA) all show significant increase in capacity while zeolites with SOD cages (FAU, LTA, EMT) display large inhibitions.

FIG. 5A shows water desorption from 13X(FAU) before and after zinc exchange compared to amorphous silica (commercial desiccant). The figure shows that desorption of water from zinc-exchanged 13X (Zn-13X) requires lower energy input than from 13X without zinc. Materials equilibrated at RT with relative humidity of 16-20%.

FIG. 5B shows breakthrough capacity and saturation capacity of silica gel, 13X and Zn-13X. Adsorption was performed at 30° C. with relative humidity of 49%.

FIG. 5C is from Son et. al., J. Chem. Eng. Data 2019, 64, 1063-1071) and shows that the present data for 13X is consistent with literature values.

FIG. 6 shows desorption of water from 13X and Zn-13X compared to a commercial amorphous silica desiccant. The results show that Zn-13X is able to desorb a larger fraction of the adsorbed water at 90° C. than 13X.

FIG. 7 shows the framework topologies of materials used in the compositions of the disclosure.

FIGS. 8A and 8B show H₂O adsorption/desorption for 13X, silica gel, SAPO-34 and Zn-13X. Zn-exchange reduces desorption energy of H₂O for both powder and bound zeolites, while it inhibits CO2 uptake. Zn-13X shows higher water capacity, compared to silica gel.

FIGS. 9A and 9B show regeneration of silica gel pellet (160-600 um) at 200&150° C. Silica gel (160-600 um) shows high recyclability, while it has low breakthrough capacity as well as diffusion kinetics.

FIGS. 10A and 10B show regeneration of 13X pellet (160-600 um) at 200&150° C. 13X is stable after 2 cycles.

FIGS. 11A and 11B show regeneration of Zn-13X pellet (160-600 um) at 200&150° C. After 2 cycles, Zn-13X (160-600 um) shows high recyclability with higher breakthrough capacity as well as faster diffusion kinetics.

FIGS. 12A and 12B show a comparison between silica gel vs. Zn-13X (pellet). Zn-13X shows 1.7 times breakthrough capacity; the two materials exhibit comparable outlet water concentration before breakthrough. Zn-13X shows faster kinetics than silica gel.

FIG. 13 show Zn-13X vs. 13X regeneration at 90&60° C. for 100 min. Zn-13X shows recyclability even at temperatures as low as 90° C. Zn-13X shows much less capacity drop than 13X at 60° C.

FIG. 14 shows comparison of silica gel, SAPO-34, 13X and Zn-13X. Zn-13X and 13X powders show much higher breakthrough capacity; Zn-13X bound material show high desorption amount of H₂O at 90° C.

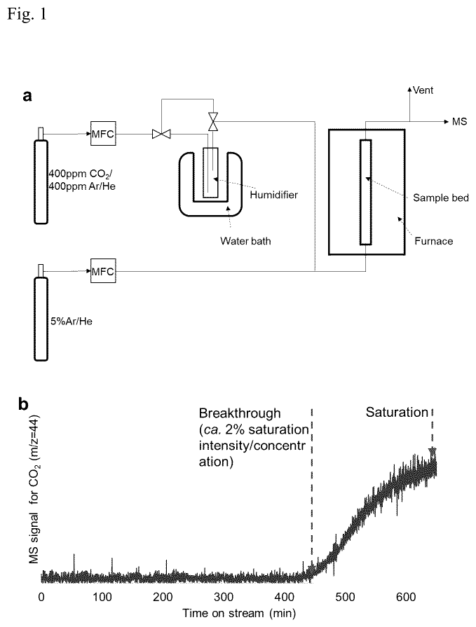

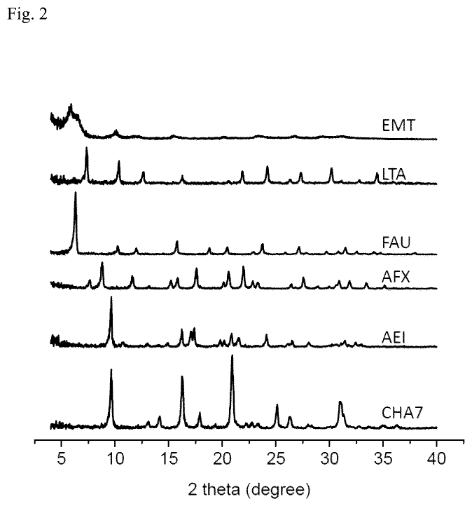

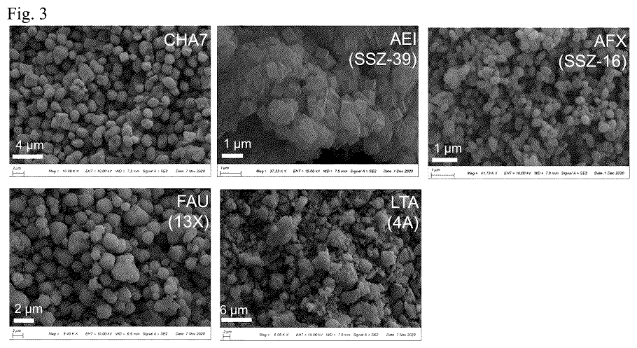

### DETAILED DESCRIPTION OF ILLUSTRATIVE EMBODIMENTS

The present disclosure is directed to new compositions of matter useful for reversibly adsorbing water from feed streams, especially gaseous feed streams. Such new compositions comprise transition metal-containing zeolites, preferably those compositions where the transition metal is zinc and the zeolites have FAU, LTA, and EMT topologies. The disclosure is also directed to methods of making and using these compositions, including configurations useful for using these compositions to extract the CO2 from gaseous feed streams.

The present invention may be understood more readily by reference to the following description taken in connection with the accompanying Figures and Examples, all of which form a part of this disclosure. It is to be understood that this invention is not limited to the specific products, methods, conditions, or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. For example, though the some of the present disclosure comments on the placement of the transition metal (zinc) ions in the zeolitic framework, the present inventions are not constrained by the correctness or incorrectness of these comments as to the placement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range. For example, a range defined as from 400 to 450 ppm includes 400 ppm and 450 ppm as independent embodiments.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of.” For those embodiments provided in terms of “consisting essentially of,” the basic and novel characteristic(s) is the facile operability of the methods or compositions/systems to provide the aluminosilicate compositions at meaningful yields (or the ability of the systems using only those ingredients listed. Other components or steps may be included, as long as these additional components or steps do not materially affect the basic and novel characteristic(s) of the claimed invention.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C,” as separate embodiments, as well as C₁₋₃.

Throughout this specification, words are to be afforded their normal meaning, as would be understood by those skilled in the relevant art. However, so as to avoid misunderstanding, the meanings of certain terms will be specifically defined or clarified.

The terms “method(s)” and “process(es)” are considered interchangeable within this disclosure.

The terms “separating” or “separated” carry their ordinary meaning as would be understood by the skilled artisan, insofar as they connote physically partitioning or isolating of one material from another or the selective capture of one component from a broader mixture. For example, in the case where the terms are used in the context of gas processing, the terms “separating” or “separated” connote a partitioning of the gases by adsorption or by permeation based on size or physical or chemical properties, as would be understood by those skilled in the art.

The term “microporous,” according to IUPAC notation refers to a material having pore diameters of less than 2 nm. Similarly, the term “macroporous” refers to materials having pore diameters of greater than 50 nm. And the term “mesoporous” refers to materials whose pore sizes are intermediate between microporous and macroporous. Within the context of the present disclosure, the material properties and applications depend on the properties of the framework such as pore size and dimensionality, cage dimensions and material composition.

“Optional” or “optionally” means that the subsequently described circumstance may or may not occur, so that the description includes instances where the circumstance occurs and instances where it does not. For example, the phrase “optionally heated” refers to both embodiments where the material is and is not heated. Similarly, the term “optionally present” refers to both embodiments where the component is and is not present. Each of these embodiments (is and is not heated or is and is not present) represents individual and independent embodiments.

As used herein, the term “crystalline microporous solids” or “crystalline microporous aluminosilicate” are crystalline structures having very regular pore structures of molecular dimensions, i.e., under 2 nm. The maximum size of the species that can enter the pores of a crystalline microporous solid is controlled by the dimensions of the channels. These materials are sometimes referred to as “molecular sieves,” having very regular pore structures of molecular dimensions, i.e., under 2 nm. The term “molecular sieve” refers to the ability of the material to selectively sort molecules based primarily on a size exclusion process. The maximum size of the species that can enter the pores of a crystalline microporous solid is controlled by the dimensions of the channels. These are conventionally defined by the ring size of the aperture, where, for example, the term “8-MR” or “8-membered ring” refers to a closed loop that is typically built from eight tetrahedrally coordinated silicon (or aluminum) atoms and eight oxygen atoms. These rings are not necessarily symmetrical, due to a variety of effects including strain induced by the bonding between units that are needed to produce the overall structure, or coordination of some of the oxygen atoms of the rings to cations within the structure. As used herein, in the context of the invention, the term “8-MR” or 8-MR zeolite” refers only to those aluminosilicate crystalline materials, or optionally substituted derivatives, having frameworks comprising 8-membered rings as the largest ring for entrance of molecules into the intracrystalline void space. Exemplary structures can identified in Baerlocher, et al., Atlas of Zeolite Framework Types, Sixth Revised Edition (2007), this reference being incorporated by reference herein for this teaching. In the present disclosure, the terms can also refer specifically to one or more compositions having FAU, LTA, and EMT topologies or any of the other topologies cited herein.

AEI topology is a three-dimensional interconnected channel system, bound by 8-membered rings 8MRs (3.8×3.8 Å) and basket-shaped cages, which are connected by double 6-membered rings (D6Rs):

AFX topology is made up of elongated larger aft cages (0.55×1.35 nm) and smaller gme cages (0.33×0.74 nm), which each joined by D6Rs units:

CHA topology is composed of D6Rs in an AABBCC sequence. All D6Rs have the same orientation, and link to other D6Rs to give a structure that contains the cha cage. Each cha cage is linked to six others via 8MR windows:

FAU topology is built by linking sodalite (SOD) cages through D6Rs, which creates a large cavity in FAU called the “supercage” accessible by a three-dimensional 12MR pore system:

LTA topology is built by linking SOD cages through double 4-membered rings, which creates a large cavity in LTA called the “supercage” accessible by a three-dimensional 8MR pore system:

EMT topology is built by linking SOD cages through double 6-membered rings, which creates a 12-membered ring channel connected with a hypocage with 12-membered ring openings.

The term “metal ion-doped” is intended to confer the same meaning as “metal ion-containing” in the context of the metal ions set forth elsewhere herein.

The term “silicate” refers to any composition including silicate (or silicon oxide) within its framework. It is a general term encompassing, for example, pure-silica (i.e., absent other detectable metal oxides within the framework), aluminosilicate, borosilicate, ferrosilicate, germanosilicate, stannosilicate, titanosilicate, or zincosilicate structures. The term “aluminosilicate” refers to any composition including both silicon and aluminum oxides within its framework. The term “zeolite” refers to an aluminosilicate composition that is a member of this family. For this reason, the terms “metal ion-doped zeolitic composition(s)” and “metal ion-doped crystalline microporous aluminosilicate composition(s)” are considered equivalent and are used interchangeably herein. Such aluminosilicates may be “pure-aluminosilicates (i.e., absent other detectable metal oxides within the framework) or optionally substituted (i.e., containing other metal oxides within the lattice framework). When described as “optionally substituted,” the respective framework may contain boron, gallium, germanium, hafnium, iron, tin, titanium, indium, vanadium, zinc, zirconium, or other atoms substituted for one or more of the atoms not already contained in the parent lattice or framework.

As used herein, the term “transition metal” refers to any element in the d-block of the periodic table, which includes groups 3 to 12 on the periodic table, as well as the elements of the f-block lanthanide and actinide series. This definition of transition metals specifically encompasses Group 4 to Group 12 elements. In certain other independent embodiments, the transition metals comprises an element of Groups 6, 7, 8, 9, 10, 11, or 12. In still other independent embodiments, the transition metal comprises scandium, yttrium, titanium, zirconium, vanadium, manganese, chromium, molybdenum, tungsten, iron, ruthenium, osmium, cobalt, rhodium, iridium, nickel, palladium, platinum, copper, silver, gold, zinc, or mixtures thereof, preferably iron, cobalt, nickel, copper, silver, and zinc.

### Compositions

In some embodiments, the disclosure is directed to metal ion-doped crystalline microporous aluminosilicate composition comprising:
a three-dimensional aluminosilicate framework comprising at least one topology that is LTA, FAU, or EMT;
wherein the crystalline microporous aluminosilicate contains metal ions positioned within the framework lattice, wherein exposure of the composition to a gas source having a total pressure in a range of from 50 kPa to 125 kPa, a CO2 content in a range of 250 to 425 ppm, and a water content in a range of 5% to 95% relative humidity at a temperature ranging from 0° C. to 70° C., results in:
(i) the composition adsorbing less CO2 on a mmol per gram basis than does the corresponding crystalline microporous aluminosilicate composition that is not metal ion-doped when exposed to the same conditions; and
(ii) the composition adsorbing from 0.5 to 200 water molecules per unit cell.

The present invention is directed to zeolitic compositions useful for reversibly extracting water from gaseous sources, including air, that can be described in compositional or functional terms, or in a combination of compositional and functional terms. In functional terms, the compositions share an enhanced capacity to capture water from humid gas mixtures.

The zeolites of the zeolitic compositions described herein share at least the following compositional and structural similarities:
(1) They are described in terms of crystalline microporous aluminosilicate composition comprising a three-dimensionally aluminosilicate framework comprising at least one topology selected from LTA, FAU, and EMT.
(2) The crystalline microporous aluminosilicate contains metal ions, preferably transition metal ions, more preferably zinc ions, positioned within the framework lattice.
(3) The metal ion-doped crystalline microporous aluminosilicate composition desorbs water at a lower temperature than the otherwise same crystalline microporous aluminosilicate composition that does not contain the metal ions when subjected to the same conditions.

Topologies which exhibit at least these structural characteristics (i.e., comprising at least one topology selected from LTA, FAU, and EMT) include LTA, FAU, or EMT. They also include topologies which contain LTA, FAU, or EMT topologies within their framework. Those zeolites having LTA, FAU, or EMT topologies are shown herein to exhibit substantially decreased temperatures required for desorption of water when appropriately doped with zinc ions. In addition, these zeolites have substantially decreased carbon dioxide adsorption capacity.

In some embodiments, the metal ion-doped crystalline microporous aluminosilicate compositions of the disclosure have a three-dimensional aluminosilicate framework that has an LTA topology.

In other embodiments, the metal ion-doped crystalline microporous aluminosilicate compositions of the disclosure have a three-dimensional aluminosilicate framework that has an FAU topology.

In other embodiments, the metal ion-doped crystalline microporous aluminosilicate compositions of the disclosure have a three-dimensional aluminosilicate framework that has an EMT topology.

Other similar zeolites which contain dor building blocks have enhanced carbon dioxide adsorption with zinc doping. For example, zeolites containing α-cages with interconnecting 8-MR openings with facing 6-membered rings associated with dor building blocks) include AEI, AFX, and CHA exhibit substantially increased capacities for CO₂ when appropriately doped with zinc ions. Cavities that are larger than 8-MR openings are referred to as the α-cages of the zeolites.

The ability of the zeolitic compositions that react positively to metal doping (i.e., that exhibit this decreased temperature for desorption of water) is shown to depend both on the Si:Al ratios of the zeolites and the transition metal ion (e.g., zinc ion) content in the zeolite. Initial results show that Si:Al ratios in a range of from 1:1 to 50:1 work well, or from 1:1 to 40:1, or from 1:1 to 6:1 especially in the presence of zinc ions.

More generally, in certain embodiments, the zeolitic compositions (i.e., the metal ion-doped crystalline microporous aluminosilicate compositions of the disclosure) have a Si:Al atomic ratio range of from 1:1 to 1.5:1, from 1.5:1 to 2:1, from 2:1 to 2.5:1, from 2.5:1 to 3:1, from 3:1 to 3.5:1, from 3.5:1 to 4:1, from 4:1 to 4.5:1, from 4.5:1 to 5:1, 5:1 to 5.5:1, from 5.5:1 to 6:1, from 6:1 to 6.5:1, from 6.5:1 to 7:1, 7:1 to 7.5:1, from 7.5:1 to 8:1, from 8:1 to 8.5:1, from 8.5:1 to 9:1, 9:1 to 9.5:1, from 9.5:1 to 10:1, from 10:1 to 15:1, from 15:1 to 20:1, from 20:1 to 25:1, from 25:1 to 30:1, from 30:1 to 35:1, from 35:1 to 40:1, from 40:1 to 45:1, from 45:1 to 50:1, from 6.5:1 to 7:1, 7:1 to 7.5:1, from 7.5:1 to 8:1, from 8:1 to 8.5:1, from 8.5:1 to 9:1, 9:1 to 9.5:1, from 9.5:1 to 10:1, from 10:1 to 11:1, from 11:1 to 12:1, 12:1 to 13:1, from 13:1 to 14:1, from 14:1 to 15:1, from 15:1 to 20:1, from 20:1 to 25:1, from 25:1 to 30:1, from 30:1 to 35:1, from 35:1 to 40:1, from 40:1 to 45:1, from 45:1 to 50:1, or a range defined by the combination of two or more of the foregoing ranges, for example from 2:1 to 4:1, from 4:1 to 8:1, from 8:1 to 12:1, or from 5.5:1 to 8.5:1.

In some embodiments, the metal ion-doped crystalline microporous aluminosilicate compositions of the disclosure have a Si:Al atomic ratio in a range of from 1:1 to 50:1.

In other embodiments, the metal ion-doped crystalline microporous aluminosilicate compositions of the disclosure have a Si:Al atomic ratio in a range of from 1:1 to 6:1.

In other embodiments, the metal ion-doped crystalline microporous aluminosilicate compositions of the disclosure have a Si:Al atomic ratio in a range of from 1.8:1 to 2.5:1.

In some embodiments, the metal ion-doped crystalline microporous aluminosilicate compositions of the disclosure have a Si:Al atomic ratio in a range of from 1:1 to 1.2:1.

In certain embodiments, the aluminosilicate framework may be substituted with one or more of boron oxide, cerium oxide, gallium oxide, germanium oxide, hafnium oxide, iron oxide, tin oxide, titanium oxide, indium oxide, vanadium oxide, or zirconium oxide.

In some aspects, the metal ion-doped crystalline microporous aluminosilicate compositions of the disclosure contain at least one metal ion, present in a range of from 0.1 to 0.5 metal ion per unit cell, from 0.5 to 1 metal ion per unit cell, from 1 to 1 to 1.25 metal ions per unit cell, from 1.25 to 1.5 metal ions per unit cell, from 1.5 to 1.75 metal ions per unit cell, from 1.75 to 2 metal ions per unit cell, from 2 to 2.25 metal ions per unit cell, from 2.25 to 2.5 metal ions per unit cell, from 2.5 to 2.75 metal ions per unit cell, from 2.75 to 3 metal ions per unit cell, from 3 to 3.25 metal ions per unit cell, from 3.25 to 3.5 metal ions per unit cell, from 3.5 to 3.75 metal ions per unit cell, from 3.75 to 4 metal ions per unit cell, from 4 to 4.25 metal ions per unit cell, from 4.25 to 4.5 metal ions per unit cell, from 4.5 to 4.75 metal ions per unit cell, from 4.75 to 5 metal ions per unit cell, from 5 to 5.25 metal ions per unit cell, from 5.25 to 5.5 metal ions per unit cell, from 5.5 to 5.75 metal ions per unit cell, from 5.75 to 6 metal ions per unit cell, from 6 to 6.5 metal ions per unit cell, from 6.5 to 7 metal ions per unit cell, from 7 to 7.5 metal ions per unit cell, from 7.5 to 8 metal ions per unit cell, from 8 to 10 metal ions per unit cell, from 10 to 12 metal ions per unit cell, from 12 to 15 metal ions per unit cell, from 15 to 17 metal ions per unit cell, from 17 to 20 metal ions per unit cell, from 20 to 22 metal ions per unit cell, from 22 to 24 metal ions per unit cell, from 24 to 26 metal ions per unit cell, from 26 to 28 metal ions per unit cell, from 28 to 30 metal ions per unit cell, from 30 to 34 metal ions per unit cell, from 34 to 37 metal ions per unit cell, from 37 to 40 metal ions per unit cell, from 40 to 42 metal ions per unit cell, from 42 to 45 metal ions per unit cell, from 45 to 50 metal ions per unit cell, from 50 to 55 metal ions per unit cell, from 55 to 60 metal ions per unit cell, from 60 to 65 metal ions per unit cell, from 65 to 70 metal ions per unit cell, from 70 to 75 metal ions per unit cell, from 75 to 80 metal ions per unit cell, from 80 to 85 metal ions per unit cell, from 80 to 87 metal ions per unit cell, from 85 to 90 metal ions per unit cell, or a range defined by two or more of the foregoing ranges, for example, from 0.1 to 4 metal ions per unit cell. Metal ion content is conveniently determined by EDS.

In some embodiments of the metal ion-doped crystalline microporous aluminosilicate compositions of the disclosure, the metal ions are transition metals.

In certain further embodiments, the metal ion-doped crystalline microporous aluminosilicate compositions of the disclosure contain at least one transition metal ion, present in a range of from 0.1 to 0.5 transition metal ion per unit cell, from 0.5 to 1 transition metal ion per unit cell, from 1 to 1 to 1.25 transition metal ions per unit cell, from 1.25 to 1.5 transition metal ions per unit cell, from 1.5 to 1.75 transition metal ions per unit cell, from 1.75 to 2 transition metal ions per unit cell, from 2 to 2.25 transition metal ions per unit cell, from 2.25 to 2.5 transition metal ions per unit cell, from 2.5 to 2.75 transition metal ions per unit cell, from 2.75 to 3 transition metal ions per unit cell, from 3 to 3.25 transition metal ions per unit cell, from 3.25 to 3.5 transition metal ions per unit cell, from 3.5 to 3.75 transition metal ions per unit cell, from 3.75 to 4 transition metal ions per unit cell, from 4 to 4.25 transition metal ions per unit cell, from 4.25 to 4.5 transition metal ions per unit cell, from 4.5 to 4.75 transition metal ions per unit cell, from 4.75 to 5 transition metal ions per unit cell, from 5 to 5.25 transition metal ions per unit cell, from 5.25 to 5.5 transition metal ions per unit cell, from 5.5 to 5.75 transition metal ions per unit cell, from 5.75 to 6 transition metal ions per unit cell, from 6 to 6.5 transition metal ions per unit cell, from 6.5 to 7 transition metal ions per unit cell, from 7 to 7.5 transition metal ions per unit cell, from 7.5 to 8 transition metal ions per unit cell, from 8 to 10 transition metal ions per unit cell, from 10 to 12 transition metal ions per unit cell, from 12 to 15 transition metal ions per unit cell, from 15 to 17 transition metal ions per unit cell, from 17 to 20 transition metal ions per unit cell, from 20 to 22 transition metal ions per unit cell, from 22 to 24 transition metal ions per unit cell, from 24 to 26 transition metal ions per unit cell, from 26 to 28 transition metal ions per unit cell, from 28 to 30 transition metal ions per unit cell, from 30 to 34 transition metal ions per unit cell, from 34 to 37 transition metal ions per unit cell, from 37 to 40 transition metal ions per unit cell, from 40 to 42 transition metal ions per unit cell, from 42 to 45 transition metal ions per unit cell, from 45 to 50 transition metal ions per unit cell, from 50 to 55 transition metal ions per unit cell, from 55 to 60 transition metal ions per unit cell, from 60 to 65 transition metal ions per unit cell, from 65 to 70 transition metal ions per unit cell, from 70 to 75 transition metal ions per unit cell, from 75 to 80 transition metal ions per unit cell, from 80 to 85 transition metal ions per unit cell, from 80 to 87 transition metal ions per unit cell, from 85 to 90 transition metal ions per unit cell, or a range defined by two or more of the foregoing ranges, for example, from 0.1 to 4 transition metal ions per unit cell. Metal ion content is conveniently determined by EDS.

In some embodiments of the metal ion-doped crystalline microporous aluminosilicate compositions of the disclosure, the metal ions are present within the framework lattice in a range of from 0.5 to 87 metal ions per unit cell.

In other embodiments of the metal ion-doped crystalline microporous aluminosilicate compositions of the disclosure, the metal ions are present within the framework lattice in a range of from 20 to 50 metal ions per unit cell.

In some embodiments of the metal ion-doped crystalline microporous aluminosilicate compositions of the disclosure, the metal ions are present within the framework lattice in a range of from 35 to 50 metal ions per unit cell.

In some embodiments of the metal ion-doped crystalline microporous aluminosilicate compositions of the disclosure, the metal ions are present within the framework lattice in a range of from 5 to 12 metal ions per unit cell.

In some embodiments of the metal ion-doped crystalline microporous aluminosilicate compositions of the disclosure, the metal ions are present within the framework lattice is about 5.5 metal ions per unit cell.

In some embodiments of the metal ion-doped crystalline microporous aluminosilicate compositions of the disclosure, the metal ions are present within the framework lattice is 5.55 metal ions per unit cell.

In some embodiments of the metal ion-doped crystalline microporous aluminosilicate compositions of the disclosure, the metal ions are present within the framework lattice in a range of from 43 to 87 metal ions per unit cell.

In some embodiments of the metal ion-doped crystalline microporous aluminosilicate compositions of the disclosure, the metal ions are present within the framework lattice is about 60 metal ions per unit cell.

In some embodiments of the metal ion-doped crystalline microporous aluminosilicate compositions of the disclosure, the metal ions are present within the framework lattice is 60 metal ions per unit cell.

In some embodiments of the metal ion-doped crystalline microporous aluminosilicate compositions of the disclosure, the metal ions are present within the framework lattice is about 17-31 metal ions per unit cell.

In some embodiments of the metal ion-doped crystalline microporous aluminosilicate compositions of the disclosure, the metal ions are present within the framework lattice is 17-31 metal ions per unit cell.

In some embodiments of the metal ion-doped crystalline microporous aluminosilicate compositions of the disclosure, the at least one transition metal ions independently comprise zironium, iron, cobalt, nickel, copper, zinc, or silver.

In some embodiments of the metal ion-doped crystalline microporous aluminosilicate compositions of the disclosure, the transition metal ions are iron, cobalt, nickel, copper, zinc, or silver ions.

In other embodiments of the metal ion-doped crystalline microporous aluminosilicate compositions of the disclosure, the transition metal ions are zinc ions.

These loadings may also be represented by other ratios, for example, transition metal ions per Al and these are considered independent embodiments. These ratios can be determined experimentally or, to a good approximation by recognizing number of atoms in the unit cell and the Si:Al ratios of the underlying zeolite. These ratio ranges, as determined by comparing the transition metal ions per unit cell and the Si/Al atoms in the corresponding unit cell, represent additional or alternative embodiments. For example, a pure aluminosilicate unit cell framework containing 39.98 Zn ions per unit cell (a FAU unit cell framework nominally has 192 atoms of Si and Al) and having a Si:Al ratio of 2.28:1 contains 87.89 Al atoms per unit cell, corresponding to about 0.455 Zn atoms/Al atoms. A range of 43.95 to 58.89 transition metal ions per 13X unit cell would correlate to 0.5 to 0.67 Zn atoms/Al atoms.

In other embodiments, the metal ion-doped crystalline microporous aluminosilicate compositions of the disclosure contains 0.69 Zn atoms per Al atom.

In some embodiments, the metal ion-doped crystalline microporous aluminosilicate compositions of the disclosure contains 60 Zn ions per unit cell.

In some embodiments, the metal ion-doped crystalline microporous aluminosilicate compositions of the disclosure contains 60 Zn atoms per unit cell and 0.69 Zn atoms per Al atom.

In some embodiments, the metal ion-doped crystalline microporous aluminosilicate compositions of the disclosure has a Si/Al ratio of 1.

In some embodiments, the metal ion-doped crystalline microporous aluminosilicate compositions of the disclosure has a Zn/Al ratio of 0.46.

In some embodiments, the metal ion-doped crystalline microporous aluminosilicate compositions of the disclosure has 5.55 Zn per unit cell.

In some embodiments, the metal ion-doped crystalline microporous aluminosilicate compositions of the disclosure has a Si/Al ratio of 1, a Zn/Al ratio of 0.46, and 5.55 Zn per unit cell.

In some embodiments, the metal ion-doped crystalline microporous aluminosilicate compositions of the disclosure has a Si/Al ratio of 1.2.

In some embodiments, the metal ion-doped crystalline microporous aluminosilicate compositions of the disclosure has a Zn/Al ratio of 0.69.

In some embodiments, the metal ion-doped crystalline microporous aluminosilicate compositions of the disclosure has 60 Zn per unit cell.

In some embodiments, the metal ion-doped crystalline microporous aluminosilicate compositions of the disclosure has a Si/Al ratio of 1.2, a Zn/Al ratio of 0.69, and 60 Zn per unit cell.

In some embodiments, the metal ion-doped crystalline microporous aluminosilicate compositions of the disclosure has a Si/Al ratio of 1.2.

In some embodiments, the metal ion-doped crystalline microporous aluminosilicate compositions of the disclosure has a Zn/Al ratio of 0.4-0.7.

In some embodiments, the metal ion-doped crystalline microporous aluminosilicate compositions of the disclosure has 17.5-30.5 Zn per unit cell.

In some embodiments, the metal ion-doped crystalline microporous aluminosilicate compositions of the disclosure has a Si/Al ratio of 1.2, a Zn/Al ratio of 0.4-0.7, and 17.5-30.5 Zn per unit cell.

Additionally or alternatively, the zeolitic compositions contain one or more ions of strontium, magnesium, calcium, indium, or barium in a range of from 0.5 to 1 ions per unit cell, from 1 to 1 to 1.25 ions per unit cell, from 1.25 to 1.5 ions per unit cell, from 1.5 to 1.75 ions per unit cell, from 1.75 to 2 ions per unit cell, from 2 to 2.25 ions per unit cell, from 2.25 to 2.5 ions per unit cell, from 2.5 to 2.75 ions per unit cell, from 2.75 to 3 ions per unit cell, from 3 to 3.25 ions per unit cell, from 3.25 to 3.5 ions per unit cell, from 3.5 to 3.75 ions per unit cell, from 3.75 to 4 ions per unit cell, from 4 to 4.25 ions per unit cell, from 4.25 to 4.5 ions per unit cell, from 4.5 to 4.75 ions per unit cell, from 4.75 to 5 ions per unit cell, from 5 to 5.25 ions per unit cell, from 5.25 to 5.5 ions per unit cell, from 5.5 to 5.75 ions per unit cell, from 5.75 to 6 ions per unit cell, from 6 to 6.5 ions per unit cell, from 6.5 to 7 ions per unit cell, from 7 to 7.5 ions per unit cell, from 7.5 to 8 ions per unit cell, from 8 to 10 ions per unit cell, from 10 to 12 ions per unit cell, from 12 to 15 ions per unit cell, from 15 to 17 ions per unit cell, from 17 to 20 ions per unit cell, from 20 to 22 ions per unit cell, from 22 to 24 ions per unit cell, from 24 to 26 ions per unit cell, from 26 to 28 ions per unit cell, from 28 to 30 ions per unit cell, from 30 to 34 ions per unit cell, from 34 to 37 ions per unit cell, from 37 to 40 ions per unit cell, from 40 to 42 ions per unit cell, from 42 to 45 ions per unit cell, from 45 to 50 ions per unit cell, from 50 to 55 ions per unit cell, from 55 to 60 ions per unit cell, from 60 to 65 ions per unit cell, or a range defined by two or more of the foregoing ranges, for example, from 2.25 to 3 ions per unit cell, or from 1.5 to 4 ions per unit cell.

Additionally or alternatively, the ion content of the zeolitic compositions may be defined in terms of the corresponding ion content per gram or unit volume of the corresponding zeolite.

Additionally or alternatively, in certain embodiments, the zeolitic compositions are defined in terms of their water content or water capacity.

In some embodiments, the content or capacity of water in the zeolitic compositions are defined in terms of molecules of water per unit cell. In certain of these embodiments, the water content or water capacity of the ion-doped (preferably zinc-doped) zeolitic compositions are in a range of from 0.5 to 200, from 0.50 to 0.6, from 0.6 to 0.65, from 0.65 to 0.7, from 0.7 to 0.75, from 0.75 to 0.8, from 0.8 to 0.85, from 0.85 to 0.9, from 0.95 to 1.0, from 1.0 to 2, from 2 to 5, from 5 to 10, from 10 to 20, from 20 to 40, from 40 to 60, from 60 to 80, from 80 to 100, from 100 to 120, from 120 to 140, from 140 to 160, from 160 to 180, from 180 to 200 adsorbed water per unit cell of the doped zeolite, when the doped zeolite is exposed to a gas source having a total pressure in a range of from 50 kPa to 75 kPa, from 75 kPa to 100 kPa, from 100 kPa to 125 kPa, from 125 kPa to 150 kPa, or a range defined by two or more of the foregoing ranges; having a water content in a range of from 5% to 15%, 15% to 25%, 25% to 35%, 35% to 45%, 45% to 55%, 55% to 65%, 65% to 75%, 85% to 95% relative humidity or a range defined by two or more of the foregoing ranges, at a temperature from 0° C. to 10° C., 10° C. to 20° C., 20° C. to 30° C., 30° C. to 40° C., 40° C. to 50° C., 50° C. to 60° C., 60° C. to 70° C., or a range defined by two or more of the foregoing ranges.

In some aspects, exposure of the metal ion-doped crystalline microporous aluminosilicate compositions of the disclosure to a gas source having a total pressure in a range of from 50 kPa to 125 kPa (e.g., 50 kPa to 75 kPa, from 75 kPa to 100 kPa, from 100 kPa to 125 kPa, from 125 kPa to 150 kPa), a CO₂ content in a range of 250 to 425 ppm, and a water content in a range of 5% to 95% (e.g., 5% to 15%, 15% to 25%, 25% to 35%, 35% to 45%, 45% to 55%, 55% to 65%, 65% to 75%, 85% to 95%) relative humidity at a temperature ranging from 0° C. to 70° C. (0° C. to 10° C., 10° C. to 20° C., 20° C. to 30° C., 30° C. to 40° C., 40° C. to 50° C., 50° C. to 60° C., 60° C. to 70° C.), results in (a) the composition adsorbing less CO₂ on a mmol per gram basis than does the corresponding crystalline microporous aluminosilicate composition that is not metal ion-doped when exposed to the same conditions; and (b) the composition adsorbing from 0.5 to 200 water molecules per unit cell.

In other embodiments, the content of water in the zeolitic compositions are defined in terms of millimoles of water per gram of zeolite. In certain of these embodiments, the water content or water capacity of the metal ion-doped (preferably zinc ion-doped) zeolitic compositions are in a range of from 0.1 to 0.2, from 0.2 to 0.3, from 0.3 to 0.4, from 0.4 to 0.45, from 0.45 to 0.5, from 0.5 to 0.55, from 0.55 to 0.6 mmol adsorbed water per gram doped zeolite, or a range defined by two or more of the foregoing ranges, when the metal ion-doped zeolite is exposed to a gas source having a total pressure in a range of from 50 kPa to 75 kPa, from 75 kPa to 100 kPa, from 100 kPa to 125 kPa, from 125 kPa to 150 kPa, or a range defined by two or more of the foregoing ranges; having a water content in a range of from 5% to 15%, 15% to 25%, 25% to 35%, 35% to 45%, 45% to 55%, 55% to 65%, 65% to 75%, 85% to 95% relative humidity or a range defined by two or more of the foregoing ranges, at a temperature from 0° C. to 10° C., 10° C. to 20° C., 20° C. to 30° C., 30° C. to 40° C., 40° C. to 50° C., 50° C. to 60° C., 60° C. to 70° C., or a range defined by two or more of the foregoing ranges.

In some aspects, the metal ion-doped crystalline microporous aluminosilicate composition of the disclosure are those wherein the metal ion-doped crystalline microporous aluminosilicate composition adsorbs less than 15 wt % (e.g., less that any one of 15%, 10%, 5%, 2%) of carbon dioxide, relative to the weight of the anhydrous metal ion-doped crystalline microporous aluminosilicate composition, when exposed to a gas source having a total pressure in a range of from 50 kPa to 125 kPa, and a CO₂ content in a range of 250 to 425 ppm.

In some embodiments, the metal ion-doped crystalline microporous aluminosilicate composition of the disclosure are those wherein the metal ion-doped crystalline microporous aluminosilicate composition adsorbs less than 10 wt % (e.g., less that any one of 10%, 9%, 8%, 7%, 6%, 5%, 4%, 3%, 2%, 1%) of carbon dioxide, relative to the weight of the anhydrous metal ion-doped crystalline microporous aluminosilicate composition, when exposed to a gas source having a total pressure in a range of from 50 kPa to 125 kPa (e.g., 50 kPa to 75 kPa, from 75 kPa to 100 kPa, from 100 kPa to 125 kPa), and a CO₂ content in a range of 250 to 425 ppm.

In other embodiments, the metal ion-doped crystalline microporous aluminosilicate composition of the disclosure are those wherein the metal ion-doped crystalline microporous aluminosilicate composition adsorbs less than 5 wt % (e.g., less that any one of 5%, 4%, 3%, 2%, 1%) of carbon dioxide, relative to the weight of the anhydrous metal ion-doped crystalline microporous aluminosilicate composition, when exposed to a gas source having a total pressure in a range of from 50 kPa to 125 kPa (e.g., 50 kPa to 75 kPa, from 75 kPa to 100 kPa, from 100 kPa to 125 kPa), and a CO₂ content in a range of 250 to 425 ppm.

In some aspects, the metal ion-doped crystalline microporous aluminosilicate composition of the disclosure are those wherein the metal ion-doped crystalline microporous aluminosilicate composition adsorbs less than 0.1 mmol of carbon dioxide per gram of anhydrous metal ion-doped crystalline microporous aluminosilicate composition, when exposed to a gas source having a total pressure in a range of from 50 kPa to 125 kPa, and a CO₂ content in a range of 250 to 425 ppm.

In some embodiments, the metal ion-doped crystalline microporous aluminosilicate composition of the disclosure are those wherein the metal ion-doped crystalline microporous aluminosilicate composition adsorbs less than 0.05 mmol of carbon dioxide per gram of anhydrous metal ion-doped crystalline microporous aluminosilicate composition, when exposed to a gas source having a total pressure in a range of from 50 kPa to 125 kPa, and a CO₂ content in a range of 250 to 425 ppm.

In some embodiments, the metal ion-doped crystalline microporous aluminosilicate composition of the disclosure are those wherein the metal ion-doped crystalline microporous aluminosilicate composition adsorbs less than 0.02 mmol of carbon dioxide per gram of anhydrous metal ion-doped crystalline microporous aluminosilicate composition, when exposed to a gas source having a total pressure in a range of from 50 kPa to 125 kPa, and a CO₂ content in a range of 250 to 425 ppm.

In some aspects, the metal ion-doped crystalline microporous aluminosilicate composition of the disclosure are those wherein carbon dioxide adsorbed to the metal ion-doped crystalline microporous aluminosilicate composition is desorbed at a temperature of less than 130° C., such as for example, a temperature of less than one of 130° C., 125° C., 120° C., 115° C., 110° C., 105° C., or 100° C.

Additionally or alternatively, in separate independent embodiments, the metal ion doped zeolitic compositions can be or are defined in their ability to desorb water. In certain of these embodiments, the metal ion doped zeolitic compositions containing water desorb their water at temperatures less than 250° C., less than 225° C., less than 200° C., less than 175° C., or less than 150° C.

In some embodiments, the metal ion-doped crystalline microporous aluminosilicate composition of the disclosure are those wherein the compositions desorbs more water on a weight % basis at a temperature in the range of 50° C.-250° C. than does the corresponding crystalline microporous aluminosilicate composition that is not metal ion-doped.

In some embodiments, the gas source has a pressure of about 100 kPa.

In other embodiments, the gas source has a water content of about 50% relative humidity at a temperature of about 30° C.

Additionally or alternatively, in separate independent embodiments, the metal ion doped zeolitic compositions adsorb less water than do their corresponding pristine (i.e., containing no metal ion dopants) zeolites. In some embodiments, the metal ion doped zeolitic compositions adsorb less than 15 wt %, less than 10 wt %, or less than 5 wt % water, relative to the weight of the anhydrous metal ion doped zeolitic compositions

Additionally or alternatively, in separate independent embodiments, the metal ion doped zeolitic compositions can be or are defined in their ability to desorb occluded water. In certain of these embodiments, the metal ion doped zeolitic compositions containing water desorb water at temperatures less than 250° C., less than 225° C., less than 200° C., less than 175° C., or less than 150° C.

In some embodiments, the metal ion-doped crystalline microporous aluminosilicate composition of the disclosure are those wherein water adsorbed to the metal ion-doped crystalline microporous aluminosilicate composition is desorbed at a temperature of less than 250° C., such, for example, a temperature of less than one of 250° C., 225° C., 220° C., 215° C., 210° C., 205° C., 200° C., 195° C., 190° C., 185° C., 180° C., 175° C., 170° C., 165° C., 160° C., 155° C., or 150° C.

This combination of high water absorption and facile water desorption at mild temperatures provides good recyclability (upwards of 10 absorption/desorption cycles at ambient atmospheric pressure) of these materials for water capture applications.

Every combination of the foregoing descriptions of topology, Si:Al ratio, metal ion and metal ion content, water content or capacity, and water absorption or desorption characteristics are considered separate and independent embodiments, as if separately explicitly defined and enumerated as such. That is, the metal ion-doped crystalline microporous aluminosilicate composition can be independently defined with respect to any of the prescribed topologies, Si:Al ratios, metals, metal loadings and/or water contents set forth elsewhere herein. For example, the compositions may be described in terms of a metal ion-doped crystalline microporous aluminosilicate composition comprising:
(a) a three-dimensionally aluminosilicate framework comprising at least one topology selected from LTA, FAU, and EMT;
(b) the crystalline microporous aluminosilicate contains metal ions, preferably transition metal ions, more preferably zinc ions, positioned within the framework lattice;
(c) wherein the metal ion-doped crystalline microporous aluminosilicate composition desorbs water at a lower temperature than the otherwise same crystalline microporous aluminosilicate composition that does not contain the metal ions when subjected to the same conditions;
(d) wherein the framework has an LTA, FAU, or EMT topology;
(e) optionally wherein the aluminosilicate has a Si:Al ratio in a range of from 1:1 to 50:1, or from 1:1 to 6:1, or 1.8:1 to 2.5:1;
(f) wherein the (transition) metal ions are present within the framework lattice in a ratio of from 0.5 to 90 metal ions per unit cell, or any one of the ranges defined elsewhere herein, including, for example, from 20 to 40 (transition) metal ions per unit cell or from about 35 to 50 transition metal ions per unit cell;
(g) wherein the metal ions are present in the framework in a range of from 10 to 90 mol % of the exchangeable cationic positions in the framework, or any one of the ranges defined elsewhere herein, preferably from about 45 to 65 mol %, more preferably from about 50 to 60 mol % of the exchangeable cationic positions in the framework; and/or
(h) optionally wherein any water adsorbed by metal ion-doped crystalline microporous aluminosilicate composition desorbs at a temperature of less than 250° C., less than 225° C., less than 200° C., less than 175° C., or less than 150° C.

Further, any of the materials or combinations of materials or steps set forth in the Examples are also considered independent embodiments of the present disclosure.

### Methods of Preparing the Inventive Compositions

The zeolitic frameworks can be prepared by methods known in the art (including, e.g., U.S. Pat. Nos. 3,140,249; 3,140,251; and 3,140,253).

These zeolitic frameworks can be further modified, for example, by incorporating metal ions (also referred to herein as dopants), such as set forth above, in the frameworks by methods also known in the art and those disclosed herein. Acetates, halides (e.g., chlorides), and nitrates are preferred sources of these doping metals. Acetate salts (or salts of other carboxylic acids) appear to be preferred; for example, zinc acetate (or other organic acid) appears to be a preferred source of zinc.

As set forth herein, different metal loadings can be achieved by washing the precursor zeolite (either pristine—no added metal—or previously loaded with metals) with aqueous solutions of specific concentrations of the metal salt(s). The aqueous salt solutions may comprise a single metal cation or multiple metal cations. The pH of the aqueous salt solution may be controlled, for example using dilute strong acid, dilute strong base, or buffer, or may be left uncontrolled. After exposure to the aqueous salt solution, the metal ion containing zeolite may be optionally rinsed with a second salt solution and/or one or more rinses of water, preferably distilled water, before drying and/or calcining the metal ion containing zeolite to remove occluded water.

In some aspects, the disclosure is directed to methods of preparing a metal ion-doped crystalline microporous aluminosilicate composition of the disclosure, the method comprising contacting a precursor crystalline microporous aluminosilicate with an aqueous solution of a salt of a metal ion.

In some embodiments, the methods of the disclosure are those further comprising rinsing the resulting metal ion-doped crystalline microporous aluminosilicate with water.

In other embodiments, the methods of the disclosure are those further comprising drying the metal ion-doped crystalline microporous aluminosilicate.

In some embodiments of the methods of preparing a metal ion-doped crystalline microporous aluminosilicate composition of the disclosure, the metal ion is a transition metal ion.

In some embodiments, the transition metal ion is iron, cobalt, nickel, copper, zinc, or silver.

In other embodiments, the transition metal ion is zinc.

### Uses of the Inventive Compositions

The metal ion-doped zeolitic compositions as disclosed herein are described as useful in extracting water from gaseous source mixtures or to otherwise separate gases. For example, these can be used to separate water and carbon dioxide from fluid streams, such as from air. Typically, the molecular sieve is used as a component in a membrane that is used to separate the gases. Examples of such membranes are disclosed in U.S. Pat. No. 6,508,860.

For each of the preceding processes described, additional corresponding embodiments include those comprising a device or system comprising or containing the materials described for each process. For example, in the gas of the gas trapping, additional embodiments include those devices known in the art as direct air capture devices In such devices, carbon dioxide is captured and stored until subject to conditions for desorption. The devices may also comprise membranes comprising the metal ion-doped zeolitic compositions useful in the processes described.

In certain embodiments, the metal ion-doped compositions may be present and/or used in a fixed bed arrangement, either suitable for its intended purpose by itself or with another material. For example, in some embodiments, the metal ion-doped compositions may be suitable for use as a desiccant without then need for additional desiccant material(s) or gas adsorption materials. In such cases, the metal ion-doped compositions may be present in a fixed bed or other suitable arrangement that allows a gaseous source mixture to pass through, over, or otherwise around these compositions. The metal ion-doped compositions may be present or used in the absence of a separate gas adsorption material, such as one that extracts CO₂, whether the gas adsorption material is present upstream (optionally proximate to, for example in a tandem fixed bed arrangement) or intermingled with the configured metal ion-doped compositions set forth herein. In other embodiments, the metal ion-doped compositions may be present or used with a gas adsorption material, either in a tandem bed (or functionally equivalent) arrangement or intermingled together. When present or used with a gas adsorption material, for example in a tandem or dual bed arrangement, the materials are configured to allow a gaseous source mixture to pass through the gas adsorption material before passing through the metal ion-doped compositions set forth herein, or pass through the gas adsorption material after passing through the metal ion-doped compositions set forth herein.

In either case, the metal ion-doped zeolitic compositions may be configured in such a way as to allow a gaseous source mixture to pass through, over, or otherwise around these compositions.

In some aspects, the disclosure is directed to methods of capturing water from a gaseous source mixture, the methods comprising contacting the gaseous source mixture with the metal ion-doped crystalline microporous aluminosilicate of the disclosure, wherein the water in the gaseous source mixture is adsorbed by the metal ion-doped crystalline microporous aluminosilicate.

In some embodiments, the methods further comprise desorbing the water from the water laden metal ion-doped crystalline microporous aluminosilicate.

In some embodiments, the methods are those wherein the contacting of the metal ion-doped crystalline microporous aluminosilicate with the gaseous source mixture is done in the absence of, or without the use of, a carbon dioxide adsorbent.

In other embodiments, the methods are those wherein the contacting of the metal ion-doped crystalline microporous aluminosilicate with the gaseous source mixture is done in the presence of, or with the use of, an added carbon dioxide adsorbent.

In some embodiments, the methods are those wherein contacting the gaseous source mixture with the metal ion-doped crystalline microporous aluminosilicate comprises passing the gaseous source mixture through a fixed-bed of adsorbent comprising the metal ion-doped crystalline microporous aluminosilicate.

In other embodiments, the methods are those wherein contacting the gaseous source mixture with the metal ion-doped crystalline microporous aluminosilicate occurs at a temperature of less than 50° C., such as, for example, at a temperature of less than one of 50° C., 45° C., 40° C., 35° C., 30° C., 25° C., 20° C., 15° C., 10° C., 5° C., or 0° C.

In other embodiments, the methods are those wherein desorbing the water from the water laden metal ion-doped crystalline microporous aluminosilicate occurs at a temperature less than 250° C., such, for example, a temperature of less than one of 250° C., 225° C., 220° C., 215° C., 210° C., 205° C., 200° C., 195° C., 190° C., 185° C., 180° C., 175° C., 170° C., 165° C., 160° C., 155° C., or 150° C.

In some embodiments, the methods are those wherein the gaseous source mixture comprises carbon dioxide.

In some embodiments, the methods are those wherein contacting the gaseous source mixture with the metal ion-doped crystalline microporous aluminosilicate comprises passing the gaseous source mixture through a fixed-bed of adsorbent comprising the metal ion-doped crystalline microporous aluminosilicate.

### EXAMPLES

The Examples set forth herein are provided to illustrate some of the concepts described within this disclosure. While each Example is considered to provide specific individual embodiments of composition, methods of preparation and use, these teachings should be considered representative of the more general disclosure; i.e., none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### Example 1: Materials and Methods

Unless otherwise noted, all reagents were purchased from commercial sources and were used as received. Unless otherwise noted all, reactions were conducted in flame-dried glassware under an atmosphere of argon.

The crystallinity of the materials was examined using powder X-ray diffraction (XRD). All powder X-ray diffraction characterization were conducted on a Rigaku MiniFlex II diffractometer with Cu Kα radiation, Kα=1.5418 Å.

Thermogravimetric analysis (TGA) was performed on a Perkin Elmer STA 6000 with a ramp of 10° C./min to 900° C. under air atmosphere. Samples (0.01-0.06 g) were placed in aluminum crucible and heated at 10 K/min in a flowing stream (0.333 cm3/s) comprised of compressed air (Airgas).

SEM analyses were performed on a ZEISS 1550 VP FESEM, equipped with an Oxford X-Max SDD. X-ray Energy Dispersive Spectrometer) (EDS) system for determining the element contents (e.g., the Si/Al ratios) of each sample. Before measurement, all zeolites were coated with Pt of about 10 nm thickness to avoid charging effects. of the samples.

All materials for synthesizing zeolites were used as-received without further purifications from the stated vendors. The moisture contents of the solid sources were determined by thermogravimetric analysis (TGA). Ludox-AS40 (40 wt % silica dispersed in water, Sigma-Aldrich) and sodium silicate (homemade, SiO2: 38.3 wt %, SiO2/Na₂O: 3.22) were used as silica source. Aluminum sources are aluminum isopropoxide (≥98%, Sigma-Aldrich), sodium aluminate (54.49 wt % Al2O3, 41.07 wt % Na₂O, 4.44 wt % H2O, Sigma-Aldrich) and FAU zeolites with a Si/Al ratio of 12 (denoted as FAU12) and Si/Al ratio of 2.6 (CBV500, Zcolyst). The organic structure directing agents (OSDAs) are N,N,N-trimethyl-1-adamantammonium hydroxide (25 wt % in H2O, TMAdaOH, Sachem), tetramethylpiperidinium hydroxide (home synthesized), 1,4-diazabicyclo[2.2.2]octane-C4-diquat dibromide. Alkaline aqueous solutions are NaOH (10 wt %, homemade), NaOH (50 wt %, Sigma-Aldrich), NaOH (IM, VWR), KOH (45 wt %, Sigma-Aldrich). The salts used for ion exchange are zinc(II) acetate dihydrate (Zn(CH₃CO₂)2·2H₂O, ≥98%, Sigma-Aldrich).

### Example 2—Synthesis of Materials

### SSZ-13 (CHA):

The synthesis of SSZ-13 zeolite was modified from the method in international zeolite association (http://www.iza-online.org/synthesis/default.htm). A molar ratio of 1 SiO2/0.05 Al2O3/0.017 TMAdaOH/0.770 Na2O/12.1 H2O was used in the synthesis solution. Typically, a 25% solution of the OSDA (TMAdaOH) was added to NaOH aqueous solution and stirred for 10 min at room temperature (RT). Then aluminum isopropoxide was added. After 21 h stirring at RT, ludox-40 was added and stirred overnight followed by adding ca. 5 wt % CHA7 seeds before charging the solution into Teflon lined autoclaves heating in a static oven to 160° C. for approximately 7 days.

### SSZ-39 (AEI):

The synthesis of SSZ-39 follows a previously reported method. M. Dusselier, et al., Chem. Mater. 2015, 27, 2695-2702. The home synthesized organic OSDA (tetramethylpiperidinium hydroxide) was combined with additional base (10 wt % NaOH) and water in a 23 mL Teflon Parr reactor followed by 20 min stirring under ambient condition. Then, the home-made silica source (sodium silicate, SiO2 28.66 wt %, Na2O 8.89 wt %, H₂O 62.45 wt %) as well as aluminum source (CBV500, a NH4-USY zeolite with Si/Al of 2.6 from Zeolyst) were added. After 1 h vigorous stirring, a homogeneous gel was obtained. The Teflon Parr reactor was then sealed and placed in a rotating oven at 140° C. for 7 days.

SSZ-16 (AFX):

Zeolite SSZ-16 was synthesized using the method reported by Zones et al. S. I. Zones, Zeolite SSZ-16, 1985, U.S. Pat. No. 4,508,837A. A homogeneous solution was prepared by mixing 0.22 grams of the SDA, 0.41 grams of the CP7182, 0.99 grams of homemade sodium silicate reagent (38% SiO2, SiO2/Na2O=3.3), 4.5 grams of 1 N NaOH solution and 0.7 grams of water. This mix gives an overall OH—/SiO2 of 0.80. The solution is charged into Teflon-lined stainless-steel autoclaves and heated to 135° C. for 4 days in an rotatory oven.

### EMT

Zeolite EMT was prepared using the method reported by Mintova et al. Cryst. Growth Des. 2015, 15, 1898-1906. Sodium aluminate solution was prepared by mixing sodium aluminate (54.49 wt % Al2O3, 41.07 wt % Na2O, 4.44 wt % H2O, Sigma-Aldrich), NaOH (50 wt %, Sigma-Aldrich) and H₂O. Sodium silicate was obtained by mixing sodium silicate (28.7 wt % SiO2, 8.9 wt % Na2O, 62.4 wt % H2O), NaOH (50 wt %, Sigma-Aldrich), H2O. Then add sodium aluminate solution into the sodium silicate solution and stir for 20 h at 40° C.

### Zeolite 13X (FAU) and 4A (LTA):

4A and 13X were obtained from Sigma-Aldrich.

After the synthesis was finished, the resulting solid was washed three times with distilled water followed by acetone washing. The crystals were dried overnight at 80° C. before calcining in an air oven under 580° C. for 8 h, with a ramp rate of 1.0° C. min-1, to remove the OSDAs. Crystallinity was evaluated with XRD.

### Example 3. Aqueous-Phase Ion-Exchange of Zeolites

Metal-zeolites were prepared by aqueous phase cation ion exchange of calcined zeolites with corresponding salt solutions. Typically, 600 mg of zeolites were added to 30 mL of salt solutions, which were then stirred at 100° C. for 24 h. Metal-zeolites were recovered via centrifugation with or without 6 times washing using distilled H₂O. For FAU, LTA and EMT zeolites, ion exchange was performed at room temperature (RT) for 2 days to prevent the dissolution of the materials. The exchanged crystals were dried at 100° C. in ambient air in a free convention oven overnight.

TABLE 1
Materials

| | | | | | Micropore |
|---|---|---|---|---|---|
| | Si/Al | Zn/Al | Zn | | volume^{b} |
| Adsorbent | ratio^{a} | ratio^{a} | wt % | Zn/U.C. | (cm³/g) |
| Zn-CHA7-1.9IE | 6.50 | 0.54 | 7.19 | 2.60 | 0.20 |
| Zn-CHA7-0.5IE | 7.00 | 0.87 | 11.10 | 3.92 | 0.18 |
| Zn-13X-0.51E | 1.00 | 0.63 | 25.71 | 60.48 | 0.18 |
| Zn-LTA-0.5IE | 0.86 | 0.43 | 20.26 | 5.55 | 0.17 |
| Zn-AEI-1.9IE | 6.28 | 0.36 | 5.12 | 2.37 | 0.22 |
| Zn-AFX-1.9IE | 3.51 | 0.25 | 5.71 | 2.66 | 0.18 |

^{a}Elemental analysis was performed using EDS.
^{b}Micropore volumes were calculated from N₂ adsorption data. The results show comparable micropore pore volumes (0.18-0.21 cm³/g) for Zn-CHA7 with Zn loading lower than 6.60 Zn/U.C.

### Example 4. Adsorption Performance Testing

The performance for CO₂ adsorption in zeolites was tested using breakthrough experiments. Typically, ˜500 mg of materials was placed in a quartz tubing (6.74 mm I.D.) to form a fixed bed. First, the adsorbent bed was purged under a 20 mL·min⁻¹ flow of 5% Ar/He gas at 550° C. for 24 h before breakthrough experiment to completely remove the water and CO₂. Upon cooling to 30° C., the gas flow was switched to the desired gas mixture (ca. 400 ppm CO₂/400 ppm Ar balanced by He) at a flow rate of 20 mL·min⁻¹. The gas flow rate was 14 mL·min⁻¹ for the simulated air (ca. 400 ppm CO₂/400 ppm Ar (internal standard)/20% O₂/79% N₂). The outlet composition was continuously monitored using a Ametek Dymaxion Dycor mass spectrometer until complete breakthrough was achieved. After each dry and wet breakthrough experiment, the packed column bed was regenerated at 550° C. for 2 h, or 100° C./60° C. for 240 min with constant 5% Ar/He flow (20 mL·min⁻¹) to test the recyclability of the materials. Experiments in the presence of ca. 49% relative humidity (RH, 20400 ppm) were performed by passing the gas stream through a water vapor saturator at 6° C. The experimental procedures for pure water adsorption are the same to those for CO₂ adsorption. The materials used for pure water adsorption was ˜100 mg.

TABLE 2
CO₂ adsorption results from materials.

| | Samples | Capacity (mmol/g) |
|---|---|---|
| FAU | FAU | 0.41 |
| | Zn-FAU-0.5IE | 0.02 |
| LTA | LTA | 0.34 |
| | Zn-LTA-0.5IE | 0.02 |
| AFX | AFX | 0.25 |
| | Zn-AFX-0.5IE | 0.23 |
| | Zn-AFX-1.9IE | 0.47 |
| | AEI | 0.06 |
| AEI | Zn-AEI-0.5IE | 0.28 |
| | Zn-AEI-1.9IE | 0.35 |
| CHA | H-CHA7 | 0.03 |
| | Zn-CHA7-0.5IE | 0.28 |
| | Zn-CHA7-1.9IE | 0.51 |

Notes:
Zn-CHA7-0.5IE denotes CHA zeolites with a Si/Al ratio of 7 was exchanged by 0.5M Zn²⁺ aqueous solution. If IE was not included, the material was not washed with distilled water after ion exchange.

The adsorption experiments were performed at 30° C. for a gas mixture of 400 ppm CO₂/400 ppm Ar (internal standard)/He.

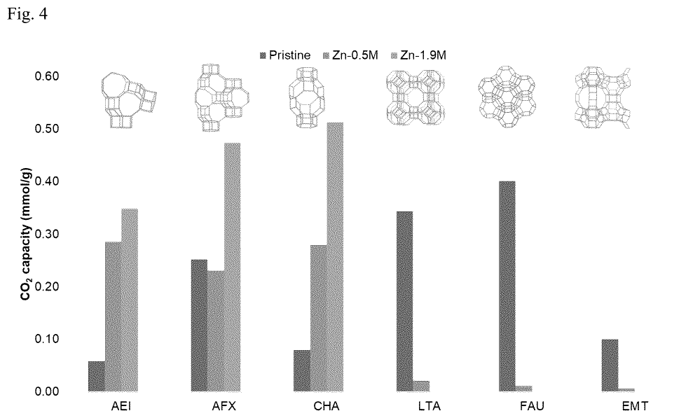

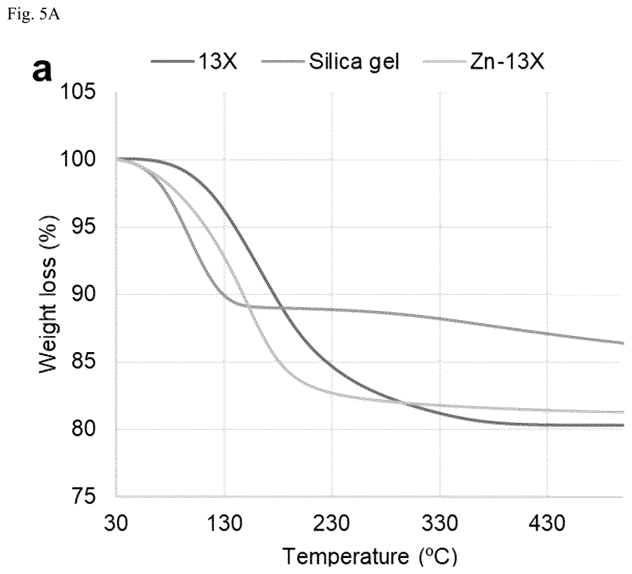

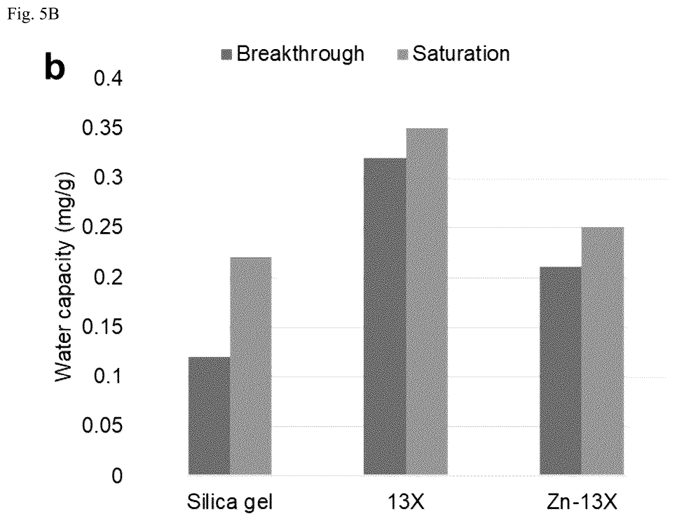

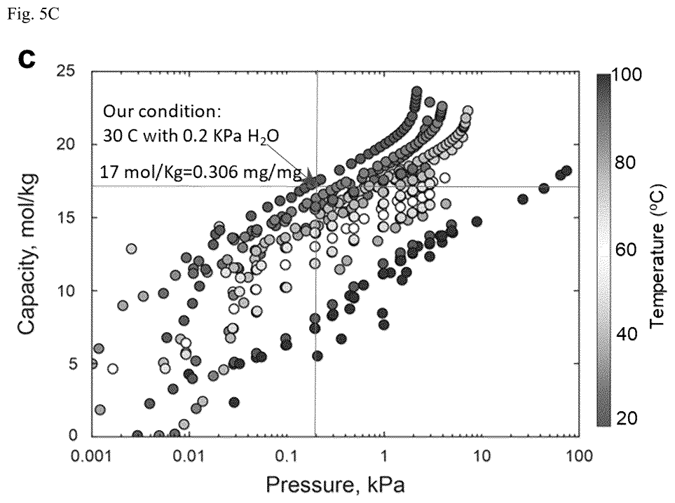

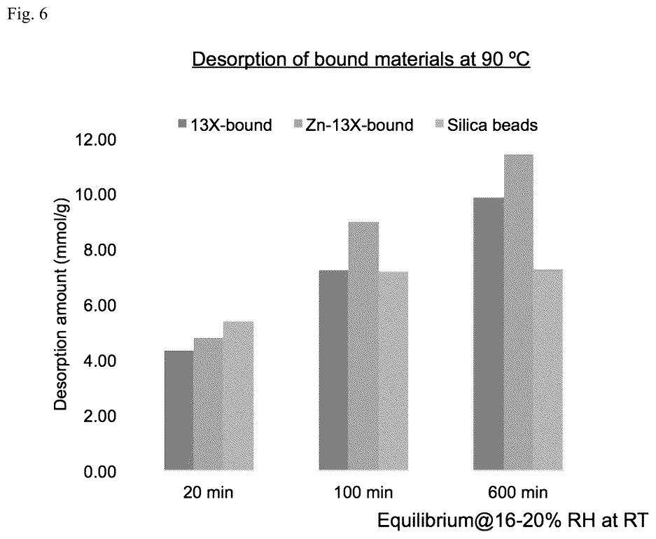

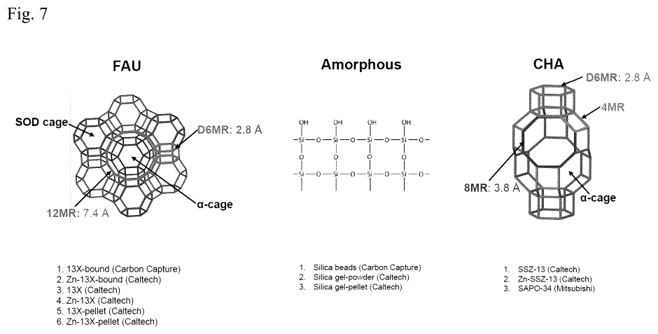

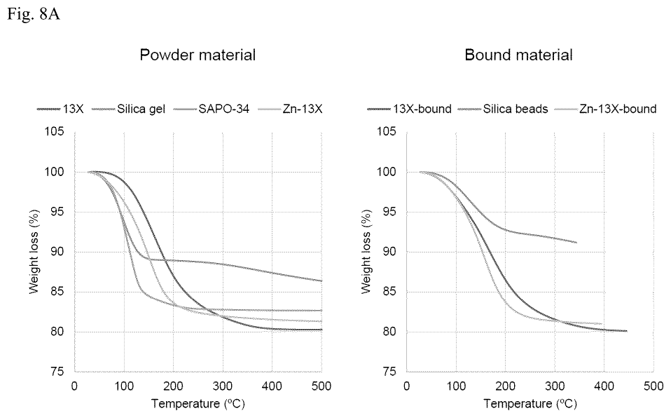

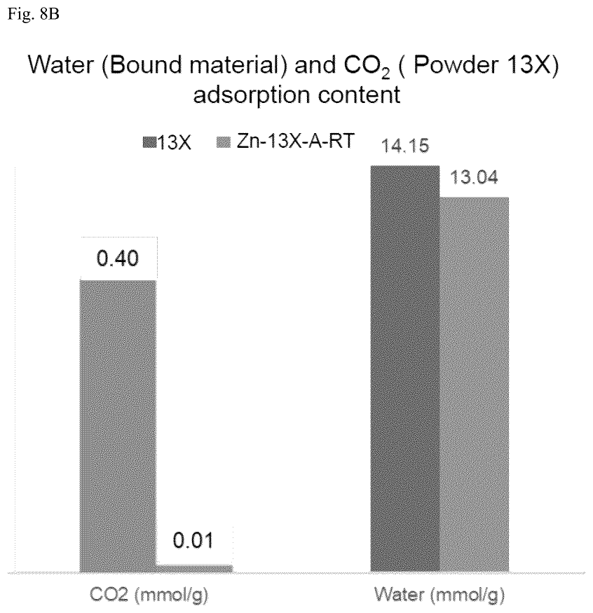

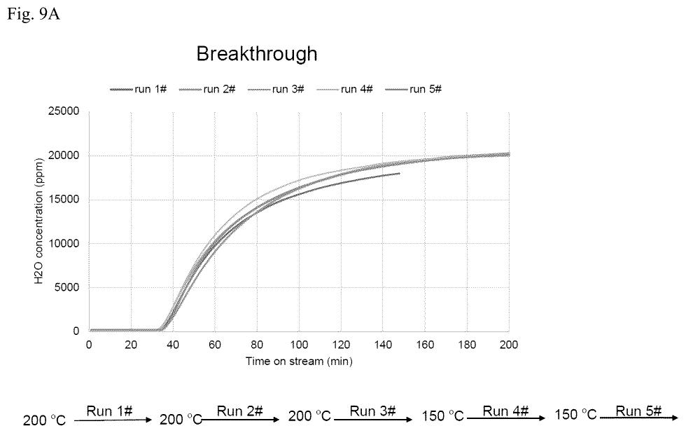

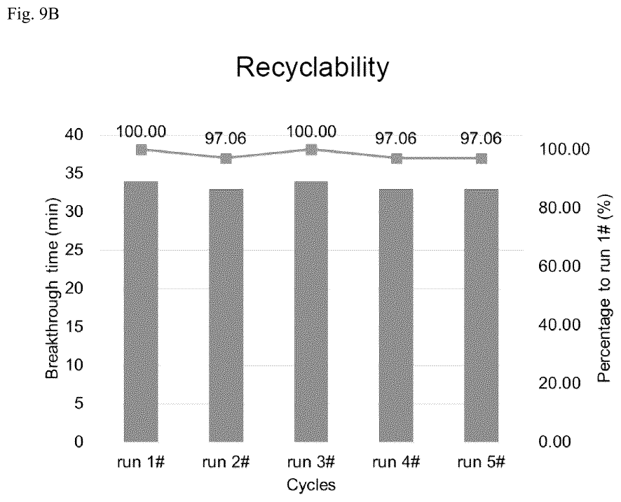

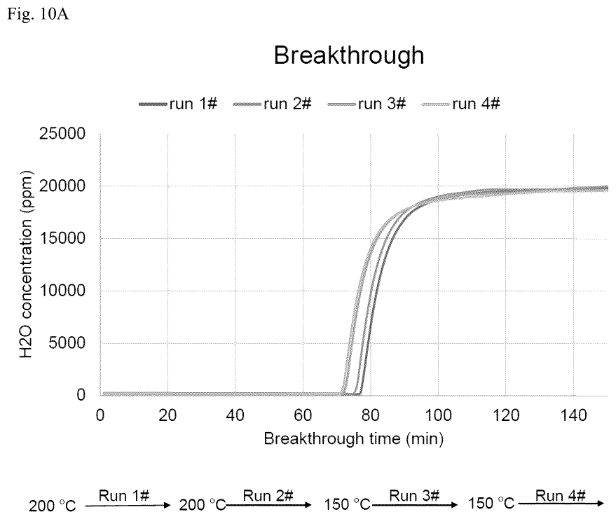

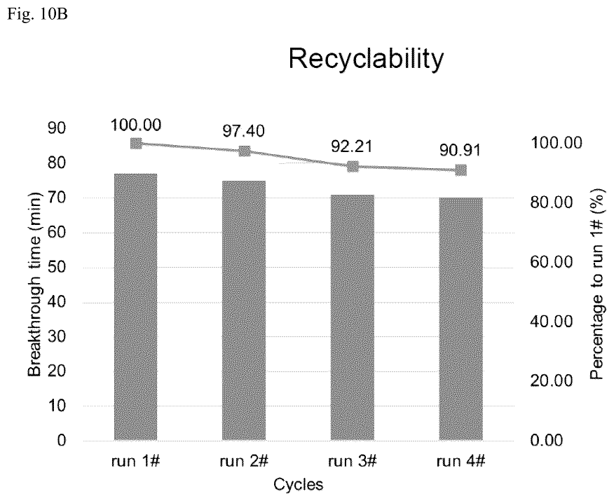

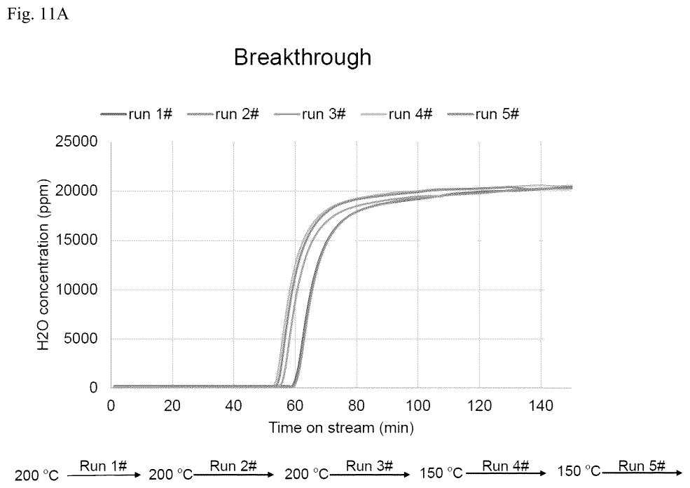

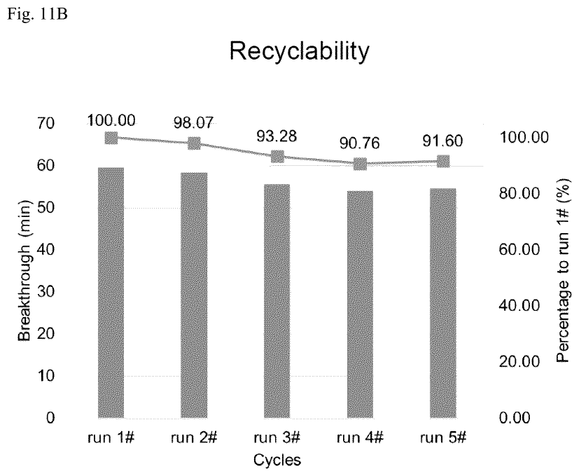

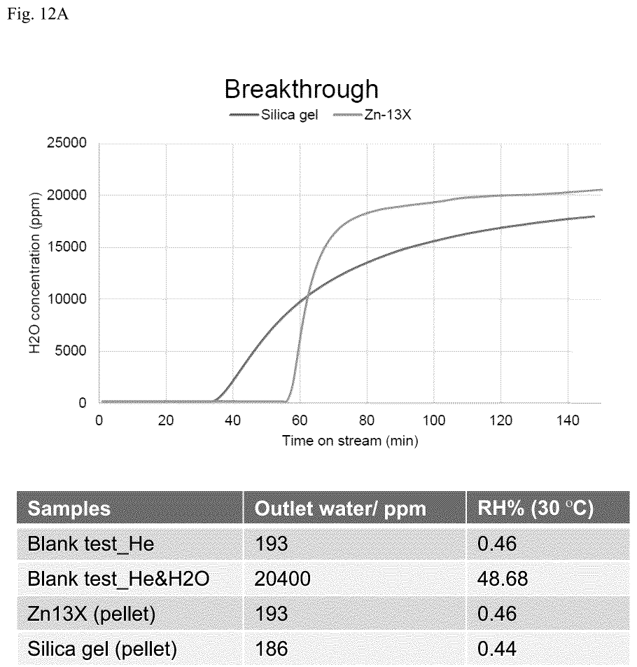

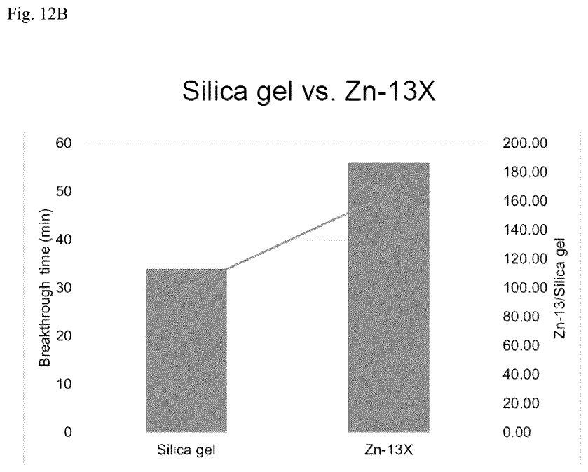

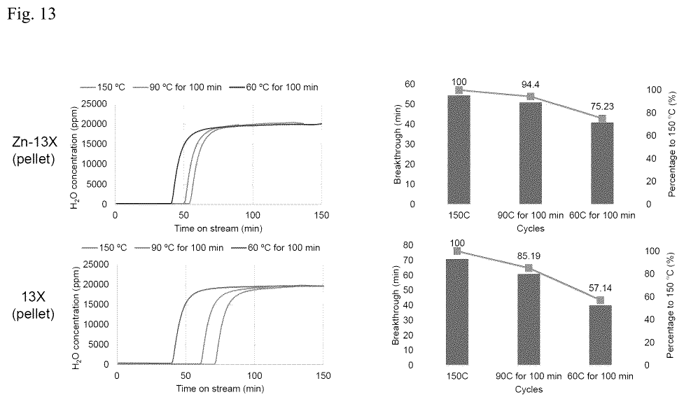

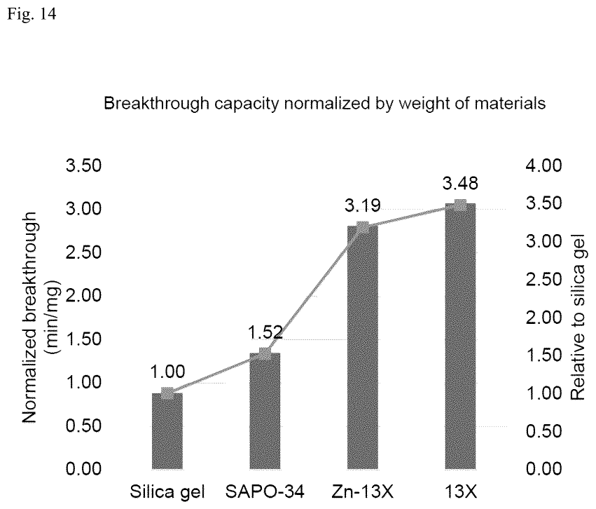

Results of adsorption/desorption experiments are summarized in FIGS. 4-6 and 8-14. These results demonstrate the following:
Zn-exchange of 13X inhibits CO₂ adsorption, while it does not dramatically alter the water adsorption capacity.
Zn-13X shows lower water desorption temperature than 13X.
Zn-13X gives greater water capacity and much faster kinetics than amorphous silica.
Zn-13X produces higher water desorption amounts than amorphous silica at 90° C.
Zn-13X and amorphous silica show comparable relative humidity in the exit stream.
Zn-13X shows recyclability even at temperatures as low as 90° C.
Zn-13X shows much less capacity drop than 13X at 60° C.

As those skilled in the art will appreciate, numerous modifications and variations of the present invention are possible in light of these teachings, and all such are contemplated hereby.

In some embodiments, the disclosure is directed to the following aspects:
Aspect 1. A metal ion-doped crystalline microporous aluminosilicate composition comprising:
a three-dimensionally aluminosilicate framework comprising at least one topology selected from LTA, FAU, and EMT;
wherein the crystalline microporous aluminosilicate contains metal ions, preferably transition metal ions, more preferably zinc ions, positioned within the framework lattice; and
wherein the metal ion-doped crystalline microporous aluminosilicate composition desorbs water at a lower temperature than the otherwise same crystalline microporous aluminosilicate composition that does not contain the metal ions when subjected to the same conditions.
Aspect 2. The metal ion-doped crystalline microporous aluminosilicate composition of aspect 1, wherein the framework has a LTA, FAU, or EMT topology.
Aspect 3. The metal ion-doped crystalline microporous aluminosilicate composition of aspect 1 or 2, which has a Si:Al atomic ratio in a range of from 1:1 to 50:1, or any one of the ranges defined elsewhere herein, including, for example in a range of from 1:1 to 6:1, or 1.8:1 to 2.5:1.
Aspect 4. The metal ion-doped crystalline microporous aluminosilicate composition of any one of aspects 1 to 3, wherein the metal ions positioned within the framework lattice comprise a transition metal ion, preferably iron, cobalt, nickel, copper, zinc, or silver, more preferably zinc.
Aspect 5. The metal ion-doped crystalline microporous aluminosilicate composition of any one of aspects 1 to 4, wherein the (transition) metal ions are present within the framework lattice in a range of from 0.5 to 90 metal ions per unit cell, or any one of the ranges defined elsewhere herein, including, for example, from 20 to 50 (transition) metal ions per unit cell or from about 35 to 50 transition metal ions per unit cell.
Aspect 6. The metal ion-doped crystalline microporous aluminosilicate composition of any one of aspects 1 to 5 that contain or have the capacity to contain water in a range of from 0.5 to 200 adsorbed water per unit cell, when the metal ion-doped crystalline microporous aluminosilicate composition is exposed to a gas source having (a) a total pressure in a range of from 50 kPa to 125 kPa, or any one of the ranges or values defined elsewhere herein, for example about 100 kPa and (b) a water content in a range of 5% to 95% relative humidity at a temperature ranging from 0° C. to 70° C., or any one of the ranges or values defined elsewhere herein.
Aspect 7. The metal ion-doped crystalline microporous aluminosilicate composition of any one of aspects 1 to 6 that contain carbon dioxide, wherein the carbon dioxide is desorbed at a temperature of less than 130° C., less than 125° C., less than 120° C., less than 115° C., less than 110° C., or less than 100° C.
Aspect 8. The metal ion-doped crystalline microporous aluminosilicate composition of any one of aspects 1 to 7 that adsorb less than 15 wt %, less than 10 wt %, or less than 5 wt % carbon dioxide, relative to the weight of the anhydrous metal ion-doped crystalline microporous aluminosilicate composition.
Aspect 9. The metal ion-doped crystalline microporous aluminosilicate composition of any one of aspects 1 to 8 that contains water, wherein the water desorbs at a temperature of less than 250° C., less than 225° C., less than 200° C., less than 175° C., or less than 150° C.
Aspect 10. A method of preparing a metal ion-doped crystalline microporous aluminosilicate composition of any one of aspects 1 to 9, the method comprising contacting a precursor crystalline microporous aluminosilicate with an aqueous solution of a salt of a suitable metal ion, and optionally rinsing the resulting metal ion-doped crystalline microporous aluminosilicate with water and/or optionally drying the metal ion-doped crystalline microporous aluminosilicate, wherein the salt is any one of the salts described elsewhere herein, and the method steps are optionally those described herein.
Aspect 11. A method of capturing water from a gaseous source mixture, the method comprising contacting the metal ion-doped crystalline microporous aluminosilicate of any one of aspects 1 to 9 with the gaseous source mixture so as to adsorb the water into the metal ion-doped crystalline microporous aluminosilicate, and optionally desorbing the water from the water laden metal ion-doped crystalline microporous aluminosilicate, preferably under a set of conditions set forth elsewhere herein.
Aspect 12. The method of aspect 11, wherein the contacting of the metal ion-doped crystalline microporous aluminosilicate with the gaseous source mixture is done in the absence or without the use of a carbon dioxide scrubber.
Aspect 13. The method of aspect 1, wherein the contacting of the metal ion-doped crystalline microporous aluminosilicate with the gaseous source mixture is done in the presence or with the use of a carbon dioxide scrubber.
Aspect 14. A metal ion-doped crystalline microporous aluminosilicate composition comprising:
a three-dimensional aluminosilicate framework comprising at least one topology that is LTA, FAU, or EMT;
wherein the crystalline microporous aluminosilicate contains metal ions positioned within the framework lattice, wherein exposure of the composition to a gas source having a total pressure in a range of from 50 kPa to 125 kPa, a CO₂ content in a range of 250 to 425 ppm, and a water content in a range of 5% to 95% relative humidity at a temperature ranging from 0° C. to 70° C., results in:
   (i) the composition adsorbing less CO₂ on a mmol per gram basis than does the corresponding crystalline microporous aluminosilicate composition that is not metal ion-doped when exposed to the same conditions; and
   (ii) the composition adsorbing from 0.5 to 200 water molecules per unit cell.
Aspect 15. The metal ion-doped crystalline microporous aluminosilicate composition of aspect 14, wherein the three-dimensional aluminosilicate framework has an LTA topology.
Aspect 16. The metal ion-doped crystalline microporous aluminosilicate composition of aspect 14, wherein the three-dimensional aluminosilicate framework has an FAU topology.
Aspect 17. The metal ion-doped crystalline microporous aluminosilicate composition of aspect 14, wherein the three-dimensional aluminosilicate framework has an EMT topology.
Aspect 18. The metal ion-doped crystalline microporous aluminosilicate composition of any one of aspects 14-17, wherein the metal ions are transition metal ions.
Aspect 19. The metal ion-doped crystalline microporous aluminosilicate composition of aspect 18, wherein the transition metal ions are iron, cobalt, nickel, copper, zinc, or silver ions.
Aspect 20. The metal ion-doped crystalline microporous aluminosilicate composition of aspect 19, wherein the transition metal ions are zinc ions.
Aspect 21. The metal ion-doped crystalline microporous aluminosilicate composition of any one of aspects 14-20, wherein the composition has a Si:Al atomic ratio in a range of from 1:1 to 50:1.
Aspect 22. The metal ion-doped crystalline microporous aluminosilicate composition of aspect 21, wherein the composition has a Si:Al atomic ratio in a range of from 1:1 to 6:1.
Aspect 23. The metal ion-doped crystalline microporous aluminosilicate composition of aspect 21, wherein the composition has a Si:Al atomic ratio in a range of from 1.8:1 to 2.5:1.
Aspect 24. The metal ion-doped crystalline microporous aluminosilicate composition of any one of aspects 14-23, wherein the metal ions are present within the framework lattice in a range of from 0.5 to 87 metal ions per unit cell.
Aspect 25. The metal ion-doped crystalline microporous aluminosilicate composition of aspect 24, wherein the metal ions are present within the framework lattice in a range of from 20 to 50 metal ions per unit cell.
Aspect 26. The metal ion-doped crystalline microporous aluminosilicate composition of aspect 24, wherein the metal ions are present within the framework lattice in a range of from 35 to 50 metal ions per unit cell.
Aspect 27. The metal ion-doped crystalline microporous aluminosilicate composition of aspect 24, wherein the metal ions are present within the framework lattice in a range of from 5 to 12 metal ions per unit cell.
Aspect 28. The metal ion-doped crystalline microporous aluminosilicate composition of aspect 24, wherein the metal ions are present within the framework lattice in a range of from 5 to 6 metal ions per unit cell.
Aspect 29. The metal ion-doped crystalline microporous aluminosilicate composition of aspect 24, wherein the metal ions are present within the framework lattice in a range of from 43 to 87 metal ions per unit cell.
Aspect 30. The metal ion-doped crystalline microporous aluminosilicate composition of aspect 24, wherein the metal ions are present within the framework lattice in a range of from 58 to 62 metal ions per unit cell.
Aspect 31. The metal ion-doped crystalline microporous aluminosilicate composition of any one of aspects 14-30, wherein the composition contains, or has the capacity to contain, from 0.5 to 200 adsorbed water molecules per unit cell.
Aspect 32. The metal ion-doped crystalline microporous aluminosilicate composition of any one of aspects 14-31, wherein the composition desorbs more water on a weight % basis at a temperature in the range of 50° C.-250° C. than does the corresponding crystalline microporous aluminosilicate composition that is not metal ion-doped.
Aspect 33. The metal ion-doped crystalline microporous aluminosilicate composition of any one of aspects 14-32, wherein the gas source has a pressure of about 100 kPa.
Aspect 34. The metal ion-doped crystalline microporous aluminosilicate composition of any one of aspects 14-33, wherein the gas source has a water content of about 50% relative humidity at a temperature of about 30° C.
Aspect 35. The metal ion-doped crystalline microporous aluminosilicate composition of any one of aspects 14-34, wherein the metal ion-doped crystalline microporous aluminosilicate composition adsorbs less than 15 wt % of carbon dioxide, relative to the weight of the anhydrous metal ion-doped crystalline microporous aluminosilicate composition, when exposed to a gas source having a total pressure in a range of from 50 kPa to 125 kPa, and a CO₂ content in a range of 250 to 425 ppm.
Aspect 36. The metal ion-doped crystalline microporous aluminosilicate composition of aspect 35, wherein the metal ion-doped crystalline microporous aluminosilicate composition adsorbs less than 10 wt % of carbon dioxide, relative to the weight of the anhydrous metal ion-doped crystalline microporous aluminosilicate composition, when exposed to a gas source having a total pressure in a range of from 50 kPa to 125 kPa, and a CO₂ content in a range of 250 to 425 ppm.
Aspect 37. The metal ion-doped crystalline microporous aluminosilicate composition of aspect 35, wherein the metal ion-doped crystalline microporous aluminosilicate composition adsorbs less than 5 wt % of carbon dioxide, relative to the weight of the anhydrous metal ion-doped crystalline microporous aluminosilicate composition, when exposed to a gas source having a total pressure in a range of from 50 kPa to 125 kPa, and a CO₂ content in a range of 250 to 425 ppm.
Aspect 38. The metal ion-doped crystalline microporous aluminosilicate composition of any one of aspects 14-37, wherein the metal ion-doped crystalline microporous aluminosilicate composition adsorbs less than 0.1 mmol of carbon dioxide per gram of anhydrous metal ion-doped crystalline microporous aluminosilicate composition, when exposed to a gas source having a total pressure in a range of from 50 kPa to 125 kPa, and a CO₂ content in a range of 250 to 425 ppm.
Aspect 39. The metal ion-doped crystalline microporous aluminosilicate composition of aspect 38, wherein the metal ion-doped crystalline microporous aluminosilicate composition adsorbs less than 0.05 mmol of carbon dioxide per gram of anhydrous metal ion-doped crystalline microporous aluminosilicate composition, when exposed to a gas source having a total pressure in a range of from 50 kPa to 125 kPa, and a CO₂ content in a range of 250 to 425 ppm.
Aspect 40. The metal ion-doped crystalline microporous aluminosilicate composition of aspect 38, wherein the metal ion-doped crystalline microporous aluminosilicate composition adsorbs less than 0.02 mmol of carbon dioxide per gram of anhydrous metal ion-doped crystalline microporous aluminosilicate composition, when exposed to a gas source having a total pressure in a range of from 50 kPa to 125 kPa, and a CO₂ content in a range of 250 to 425 ppm.
Aspect 41. The metal ion-doped crystalline microporous aluminosilicate composition of any one of aspects 14-41, wherein carbon dioxide adsorbed to the metal ion-doped crystalline microporous aluminosilicate composition is desorbed at a temperature of less than 130° C.
Aspect 42. The metal ion-doped crystalline microporous aluminosilicate composition of aspect 41, wherein carbon dioxide adsorbed to the metal ion-doped crystalline microporous aluminosilicate composition is desorbed at a temperature of less than 125° C.
Aspect 43. The metal ion-doped crystalline microporous aluminosilicate composition of aspect 41, wherein carbon dioxide adsorbed to the metal ion-doped crystalline microporous aluminosilicate composition is desorbed at a temperature of less than 115° C.
Aspect 44. The metal ion-doped crystalline microporous aluminosilicate composition of aspect 41, wherein carbon dioxide adsorbed to the metal ion-doped crystalline microporous aluminosilicate composition is desorbed at a temperature of less than 110° C.
Aspect 45. The metal ion-doped crystalline microporous aluminosilicate composition of aspect 41, wherein carbon dioxide adsorbed to the metal ion-doped crystalline microporous aluminosilicate composition is desorbed at a temperature of less than 100° C.
Aspect 46. The metal ion-doped crystalline microporous aluminosilicate composition of any one of aspects 14-45, wherein water adsorbed to the metal ion-doped crystalline microporous aluminosilicate composition is desorbed at a temperature of less than 250° C.
Aspect 47. The metal ion-doped crystalline microporous aluminosilicate composition of aspect 46, wherein water adsorbed to the metal ion-doped crystalline microporous aluminosilicate composition is desorbed at a temperature of less than 225° C.
Aspect 48. The metal ion-doped crystalline microporous aluminosilicate composition of aspect 46, wherein water adsorbed to the metal ion-doped crystalline microporous aluminosilicate composition is desorbed at a temperature of less than 200° C.
Aspect 49. The metal ion-doped crystalline microporous aluminosilicate composition of aspect 46, wherein water adsorbed to the metal ion-doped crystalline microporous aluminosilicate composition is desorbed at a temperature of less than 175° C.
Aspect 50. The metal ion-doped crystalline microporous aluminosilicate composition of aspect 46, wherein water adsorbed to the metal ion-doped crystalline microporous aluminosilicate composition is desorbed at a temperature of less than 150° C.
Aspect 51. A method of preparing a metal ion-doped crystalline microporous aluminosilicate composition of any one of aspects 14-50, the method comprising contacting a precursor crystalline microporous aluminosilicate with an aqueous solution of a salt of a metal ion.
Aspect 52. The method of aspect 51, further comprising rinsing the resulting metal ion-doped crystalline microporous aluminosilicate with water.
Aspect 53. The method of aspect 51 or aspect 52, further comprising drying the metal ion-doped crystalline microporous aluminosilicate.
Aspect 54. The method of any one of aspects 51-53, wherein the metal ion is a transition metal ion.
Aspect 55. The method of any one of aspects 51-54, wherein the (transition) metal ion is iron, cobalt, nickel, copper, zinc, or silver.
Aspect 56. The method of any one of aspects 51-55 wherein the transition metal ion is zinc.
Aspect 57. A method of capturing water from a gaseous source mixture, the method comprising contacting the gaseous source mixture with the metal ion-doped crystalline microporous aluminosilicate of any one of aspects 14-56, wherein the water in the gaseous source mixture is adsorbed by the metal ion-doped crystalline microporous aluminosilicate.
Aspect 58. The method of aspect 57, further comprising desorbing the water from the water laden metal ion-doped crystalline microporous aluminosilicate.
Aspect 59. The method of aspect 57 or aspect 58, wherein the contacting of the metal ion-doped crystalline microporous aluminosilicate with the gaseous source mixture is done in the absence of, or without the use of, a carbon dioxide adsorbent.
Aspect 60. The method of aspect 57 or aspect 58, wherein the contacting of the metal ion-doped crystalline microporous aluminosilicate with the gaseous source mixture is done in the presence of, or with the use of, an added carbon dioxide adsorbent.
Aspect 61. The method of any one of aspects 57-60, wherein contacting the gaseous source mixture with the metal ion-doped crystalline microporous aluminosilicate comprises passing the gaseous source mixture through a fixed-bed of adsorbent comprising the metal ion-doped crystalline microporous aluminosilicate.
Aspect 62. The method of any one of aspects 57-61, wherein contacting the gaseous source mixture with the metal ion-doped crystalline microporous aluminosilicate occurs at a temperature of less than 50° C.
Aspect 63. The method of any one of aspects 58-62, wherein desorbing the water from the water laden metal ion-doped crystalline microporous aluminosilicate occurs at a temperature less than 250° C.
Aspect 64. The method of any one of aspects 57-63, wherein the gaseous source mixture comprises carbon dioxide.
Aspect 65. The method of any one of aspects 57-64, wherein contacting the gaseous source mixture with the metal ion-doped crystalline microporous aluminosilicate comprises passing the gaseous source mixture through a fixed-bed of adsorbent comprising the metal ion-doped crystalline microporous aluminosilicate.

What is claimed:

1. A method of capturing water from a gaseous source mixture, the method comprising:
contacting the gaseous source mixture with a metal ion-doped crystalline microporous aluminosilicate composition having a three-dimensional aluminosilicate framework comprising at least one topology that is LTA, FAU, or EMT;
wherein the crystalline microporous aluminosilicate contains metal ions positioned within the framework lattice;
wherein the water in the gaseous source mixture is adsorbed by the metal ion-doped crystalline microporous aluminosilicate;
wherein the composition desorbs more water on a weight % basis at a temperature in the range of 50° C.-250° C. than does the corresponding composition that is not metal ion-doped when exposed to the same conditions; and
wherein contacting the composition with a gaseous source mixture having a total pressure in a range of from 50 kPa to 125 kPa, and a CO₂ content in a range of 250 to 425 ppm results in the composition adsorbing less than 15 wt % of carbon dioxide from the gaseous source mixture.

2. The method of claim 1, wherein the gaseous source mixture has a total pressure in a range of from 50 kPa to 150 kPa, a CO₂ content in a range of 250 to 425 ppm, and a water content in a range of 5% to 95% relative humidity at a temperature ranging from 0° C. to 70° C.

3. The method of claim 1, wherein the gaseous source mixture has a total pressure in a range of from 50 kPa to 150 kPa, and a water content in a range of 5% to 95% relative humidity at a temperature ranging from 0° C. to 70° C.

4. The method of claim 1, wherein the metal ion-doped crystalline microporous aluminosilicate composition adsorbs from 0.5 to 200 water molecules per unit cell.

5. The method of claim 1, wherein the metal ion-doped crystalline microporous aluminosilicate composition adsorbs from 0.1 to 0.6 mmol water per gram of the composition.

6. The method of claim 1, further comprising desorbing the adsorbed water from the composition at a temperature of less than 250° C.

7. The method of claim 1, further comprising desorbing the adsorbed water from the composition at a temperature of less than 175° C.

8. The method of claim 1, wherein the composition desorbs water at a lower temperature than does the corresponding composition that is not metal ion-doped when exposed to the same conditions.

9. The method of claim 1, wherein contacting the gaseous source mixture with the composition occurs at a temperature of less than 50° C.

10. The method of claim 1, wherein the gaseous source mixture contacts the composition by passing the gaseous source mixture through a fixed-bed of adsorbent comprising the composition.

11. The method of claim 1, wherein the three-dimensional aluminosilicate framework has an LTA topology.

12. The method of claim 1, wherein the three-dimensional aluminosilicate framework has an FAU topology.

13. The method of claim 1, wherein the three-dimensional aluminosilicate framework has an EMT topology.

14. The method of claim 1, wherein the metal ions are transition metal ions.

15. The method of claim 1, wherein the metal ions comprise iron, cobalt, nickel, copper, zinc, or silver ions.

16. The method of claim 1, wherein the metal ions comprise zinc ions.

17. The method of claim 1, wherein the composition has a Si:Al atomic ratio in a range of from 1:1 to 50:1.

18. The method of claim 1, wherein the composition has a Si:Al atomic ratio in a range of from 1:1 to 6:1.

19. The method of claim 1, wherein the metal ions are present within the framework lattice in a range of from 0.5 to 87 metal ions per unit cell.

20. The method of claim 1, wherein the gaseous source mixture includes carbon dioxide which is adsorbed by the composition; and further comprising desorbing the adsorbed carbon dioxide from the composition at a temperature of less than 130° C.
